SEQUENCE LISTING (2 sequences)

SEQ ID NO: 1 - protein, 23 aa, Artificial Sequence
  Synthetic Construct
IEEQAKTFLDKFNHEAEDLFYQS

SEQ ID NO: 2 - protein, 13 aa, Artificial Sequence
  Synthetic Construct
LVMGLNVWLRYSK

(19) United States
(12) Patent Application Publication
(10) Pub. No.: US 2024/0369491 A1
(43) Pub. Date: Nov. 7, 2024

(54) DETECTION OF A TARGET VIRUS VIA SURFACE ENHANCED RAMAN SPECTROSCOPY (SERS) USING A PEPTIDE-MODIFIED NANOSTRUCTURED METAL

(71) Applicants: Ohio State Innovation Foundation, Columbus, OH (US); THE UNIVERSITY OF NORTH CAROLINA AT CHAPEL HILL, Chapel Hill, NC (US)

(72) Inventors: Taylor PAYNE, Columbus, OH (US); Zachary SCHULTZ, Worthington, OH (US); Ronit FREEMAN, Chapel Hill, NC (US); Stephen KLAWA, Chapel Hill, NC (US)

(21) Appl. No.: 18/572,427

(22) PCT Filed: Mar. 24, 2022
(86) PCT No.: PCT/US2022/021691

§ 371 Date: Dec. 20, 2023

Related U.S. Application Data
(60) Provisional application No. 63/212,983, filed on Jun. 21, 2021.

(51) Int. Cl. G01N 21/65

(52) U.S. Cl. CPC G01N 21/658

(57) ABSTRACT

Disclosed herein are compositions, devices, systems, and methods for detection of a target virus via Surface Enhanced Raman Spectroscopy (SERS) using a peptide-modified nanostructured metal.

### CROSS-REFERENCE TO RELATED APPLICATIONS

This application claims the benefit of priority to U.S. Provisional Application No. 63/212,983 filed Jun. 21, 2021, which is hereby incorporated herein by reference in its entirety.

### STATEMENT OF GOVERNMENT SUPPORT

This invention was made with government support under grant/contract numbers P30 CA016058 awarded by the National Institutes of Health and grant/contract number 2107791 awarded by the National Science Foundation. The government has certain rights in the invention.

### BACKGROUND

The swift and accurate diagnosis of COVID-19 and other viruses remains a critical factor in preventing their spread. Current detection methods include polymerase chain reaction (PCR), which requires long run times and significant sample preparation, and antibody testing, which suffers from high false negative rates and detects an immune response from the virus rather than the virus itself. In addition, diagnostic assays that are rapidly adaptable to virus mutations and variants are needed, as the rapid proliferation of the virus can alter the nucleic acid sequence or surface marker of the virus, rendering it undetectable by current methods. There remains a need for a quick, selective, and error-free sensors for viruses, such as SARS-CoV-2. The compositions, devices, methods, and systems discussed herein address these and other needs.

### SUMMARY

In accordance with the purposes of the disclosed compositions, devices, methods, and systems as embodied and broadly described herein, the disclosed subject matter relates to detection of a target virus via Surface Enhanced Raman Spectroscopy (SERS) using a peptide-modified nanostructured metal.

For example, disclosed herein are assays for detection of a target virus via Surface Enhanced Raman Spectroscopy (SERS), the assays comprising: a peptide-modified nanostructured metal comprising a nanostructured metal having a first plurality of peptides attached to a surface thereof, wherein each of the first plurality of peptides comprises a capture portion configured to capture and bind with at least a first portion of the target virus, and wherein the surface of the nanostructured metal is configured to enhance a Raman signal of at least a second portion of the target virus bound to the capture portion of one or more of the first plurality of peptides.

In some examples, the nanostructured metal comprises a metal selected from the group consisting of Ru, Rh, Pd, Os, Ir, Pt, Au, Ag, Cu, Al, and combinations thereof. In some examples, the nanostructured metal comprises a metal selected from the group consisting of Pt, Au, Ag, Cu, Al, and combination thereof. In some examples, the nanostructured metal comprises a metal selected from the group consisting of Au, Ag, and combinations thereof.

In some examples, the nanostructured metal comprises a metal modified with a nanostructure.

In some examples, the nanostructured metal comprises a plurality of metal particles. In some examples, the metal particles have an isotropic shape or an anisotropic shape. In some examples, the metal particles have an average particle size of from 5 nanometers (nm) to 1 micrometer (Micron, μm). In some examples, the plurality of peptide-modified particles are at least partially dispersed in a solvent. In some examples, the solvent comprises water. In some examples, the plurality of peptide-modified particles are disposed on a substrate.

In some examples, the surface of the nanostructured metal further comprises a plurality of ligands attached thereto. In some examples, the plurality of ligands comprise a short chain thiol, such as 2-mercaptoethanol. In some examples, the plurality of ligands comprise a second plurality of peptides. In some examples, the peptide-modified nanostructured metal comprises a first population and a second population, the first population being modified with the first plurality of peptides and the second population being modified with the second plurality of peptides. In some examples, the nanostructured metal comprises a plurality of metal particles such that the assay comprises a plurality of peptide-modified metal particles, the plurality of peptide-modified metal particles comprising a first population of metal particles modified with the first plurality of peptides and a second population of metal particles modified with the second plurality of peptides.

In some examples, each of the second plurality of peptides has a binding portion configured to capture and bind to at least a first portion of a second target virus. In some examples, the second target virus is different than the first target virus. In some examples, the first target virus is a first variant of a virus and the second target virus is a second variant of the virus, the first variant being different than the second variant. In some examples, the second target virus can comprise an influenza virus, a coronavirus, or a combination thereof.

In some examples, each of the first plurality of peptides further includes a first spacer portion, the first spacer portion being adjacent the capture portion and configured to space the capture portion away from the surface of the nanostructured metal. In some examples, the first spacer portion comprises a substituted or unsubstituted aliphatic chain, an amino acid, a third peptide, or a combination thereof. In some examples, the first spacer portion comprises poly(ethylene glycol). In some examples, the first spacer portion has an average length of from 1 nm to 10 nm.

In some examples, each of the second plurality of peptides further includes a second spacer portion, the second spacer portion being adjacent the binding portion and configured to space the binding portion away from the surface of the nanostructured metal. In some examples, the second spacer portion comprises a substituted or unsubstituted aliphatic chain, an amino acid, a third peptide, or a combination thereof. In some examples, the second spacer portion has an average length of from 1 nm to 10 nm.

In some examples, the first plurality of peptides and/or the second plurality of peptides independently further comprises a SEES reporter. In some examples, the SERS reporter comprises an organic dye, an organic molecule, a metal particle, or a combination thereof.

In some examples, the first portion of the target virus comprises a viral protein. In some examples, the first portion of the target virus is a surface protein.

In some examples, the target virus comprises one or more variants of SARS-CoV-2. In some examples, the target virus comprises one or more variants of SARS-CoV-2 and wherein the first portion of the target virus comprises the SARS-CoV-2 spike protein. In some examples, the target virus comprises one or more variants of SARS-CoV-2 and wherein the first portion of the target virus comprises the SARS-CoV-2 spike protein receptor binding domain.

In some examples, the capture portion of each of the first plurality of peptides is configured to selectively bind the first portion of the target virus In some examples, the capture portion of each of the first plurality of peptides has an average length of from 3 to 60 amino acids.

In some examples, the binding portion of each of the second plurality of peptides has an average length of from 3 to 60 amino acids.

In some examples, the capture portion of each of the first plurality of peptides and/or the binding portion of each of the second plurality of peptides independently is a biomimetic peptide.

In some examples, the capture portion of each of the first plurality of peptides comprises an angiotensin-converting enzyme 2 (ACE2) mimetic peptide.

In some examples, the target virus comprises one or more variants of SARS-CoV-2 and wherein the capture portion of each of the first plurality of peptides comprises at least 90% identity to IEEQAKTFLDKFNHEAEDLFYQS (SEQ ID NO: 1) or LVMGLNVWLRYSK (SEQ ID NO:2) In some examples, the target virus comprises one or more variants of SARS-CoV-2 and the capture portion of each of the first plurality of peptides is engineered to engage with at least a portion of the spike protein of SARS-CoV-2. In some examples, the target virus comprises one or more variants of SARS-CoV-2 and wherein the capture portion of each of the first plurality of peptides is configured to selectively bind the first portion of the one or more SARS-CoV-2 variants. In some examples, the target virus comprises one or more variants of SARS-CoV-2 and wherein the capture portion of each of the first plurality of peptides is configured to selectively bind the first portion of the one or more variants of SARS-CoV-2 relative to SARS-CoV-1, MERS-CoV, or a combination thereof.

In some examples, the first plurality of peptides are attached to the surface of the nanostructured metal substantially homogeneously across the surface of said nanostructured metal.

Also disclosed herein are methods of making any of the assays disclosed herein. The methods can, for example, comprise making the peptide-modified nanostructured metal. In some examples, the method comprises contacting the nanostructured metal with a plurality of peptides having a functional group configured to covalently or ionically bond to the nanostructured metal.

In some examples, the methods further comprise making the nanostructured metal. In some examples, the methods further comprise making the first plurality of peptides having the functional group.

Also disclosed herein are methods comprising: contacting any of the assays disclosed herein 44 with a liquid sample; subsequently collecting a surface enhanced Raman signal from the liquid sample and the assay; and processing the surface enhanced Raman signal to determine a property of the liquid sample.

In some examples, the liquid sample comprises a bodily fluid. In some examples, the bodily fluid comprises saliva, sputum, nasal secretions, pharyngeal exudates, bronchoalveolar lavage, tracheal aspirations, mucous, or a combination thereof.

In some examples, the method further comprises collecting the liquid sample. In some examples, the liquid sample is collected using a nasal or oropharyngeal swab. In some examples, the liquid sample is collected in a vial. In some examples, the method further comprises purifying the liquid sample before contacting the liquid sample with the assay. In some examples, purifying the liquid sample comprises filtering, centrifuging, electrophoresis, or a combination thereof.

In some examples, the liquid sample further comprises serum albumin. In some examples, the method further comprises adding serum albumin to the liquid sample before or concurrently with contacting the liquid sample with the assay.

In some examples, the liquid sample has a volume of from 1 microliter (μL) to 50 milliliters (mL).

In some examples, the property of the liquid sample comprises the presence of the target virus the liquid sample, the concentration of the target virus in the liquid sample, the identity of the target virus, the identity of the variant of the target virus, or a combination thereof.

In some examples, the target virus comprises one or more variants of SARS-CoV-2 and wherein the property of the liquid sample comprises the presence of one or more SARS-CoV-2 variants in the liquid sample, the concentration of one or more SARS-CoV-2 variants in the liquid sample, the identity of one or more variants of SARS-CoV-2 in the liquid sample, or a combination thereof.

In some examples, the methods further comprise diagnosing and/or monitoring an infection with the target virus in a subject based on the property of the liquid sample. In some examples, the methods further comprise selecting a course of therapy for the subject based on the property of the liquid sample.

In some examples, processing the surface enhanced Raman signal to determine the property of the liquid sample comprises multivariate analysis of peak characteristics. In some examples, processing the surface enhanced Raman signal to determine the property of the liquid sample comprises comparing to a standard curve.

Also disclosed herein are devices comprising: a receptacle configured to at least partially contain any of the assays disclosed herein; an excitation source; a detector; and a computing device; wherein the receptacle is further configured to position the assay such that the assay is in optical communication with the excitation source and the detector; and wherein the computing device is configured to receive and process an electromagnetic signal from the detector: wherein, when the device is assembled together with a liquid sample, then: the receptacle is configured to at least partially contain the assay in contact with the liquid sample and position the assay in contact with the liquid sample such that the assay and the liquid sample are in optical communication with the excitation source and the detector; the excitation source is configured to apply an excitation signal to the liquid sample and the assay; the detector is configured to collect a surface enhanced Raman signal from the liquid sample and the assay; and the computing device is configured to process the surface enhanced Raman signal to determine a property of the liquid sample.

In some examples, the excitation source and/or the detector comprise a Raman spectrometer.

In some examples, the device is further configured to output the property of the liquid sample and/or a feedback signal based on the property of the liquid sample. In some examples, the amount of time from contacting the liquid sample to output is from 1 second to 1 hour. In some examples, the feedback signal comprises haptic feedback, auditory feedback, visual feedback, or a combination thereof.

In some examples, the device is a point-of-care device. In some examples, the device is a handheld device. In some examples, the device is a benchtop device. In some examples, the device is a high-throughput device.

In some examples, the device is configured to analyze a plurality of liquid samples.

Additional advantages of the disclosed compositions, devices, systems, and methods will be set forth in part in the description which follows, and in part will be obvious from the description. The advantages of the disclosed compositions, devices, systems, and methods will be realized and attained by means of the elements and combinations particularly pointed out in the appended claims. It is to be understood that both the foregoing general description and the following detailed description are exemplary and explanatory only and are not restrictive of the disclosed compositions, devices, systems, and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1 is a schematic illustration of an example device as disclosed herein.

FIG. 2 is a schematic illustration of an example handheld device as disclosed herein.

FIG. 3 is a schematic illustration of an example computing device.

FIG. 4. Peptide-based SERS sensor for SARS-CoV-2.

FIG. 5. Schematic of peptide-modified SERS substrates (i) before (left) and (ii) after (right) binding the spike protein of SARS-CoV-2.

FIG. 6. Chemical structure and expected mass of Cys-SBP peptide.

FIG. 7. Analytical HPLC (monitoring peptide absorbance at 214 nm) confirmed the Cys-SBP peptide identity and high purity.

FIG. 8. ESI-MS confirmed the Cys-SBP peptide identity and high purity.

FIG. 9. Chemical structure and expected mass of Cys-SBP-PEG₄ peptide.

FIG. 10. Analytical HPLC (monitoring peptide absorbance at 214 nm) confirmed the Cys-SBP-PEG₄ peptide identity and high purity.

FIG. 11. ESI-MS confirmed the Cys-SBP-PEG₄ peptide identity and high purity.

FIG. 12. Sequence and chemical structure of ACE2-derived peptide used to modify surfaces and bind the spike protein.

FIG. 13. Normalized XPS spectra of SERS substrates showing peptide modification and RBD binding.

FIG. 14. Normalized XPS spectra of SBP modified substrates before and after RBD binding.

FIG. 15. Atomic ratios quantified from XPS spectra shown in FIG. 14 of SBP modified substrates before and after RBD binding. N:Au ratios are 0.85 and 1.31 for SBP and SBP+RBD surfaces, respectively. Low atomic percent values for N and Au on the SBP+RBD surface are likely a result of residual hydrocarbon contamination on the surface.

FIG. 16. Atomic composition of surfaces used in FIG. 13 showing successful modification and RBD binding.

FIG. 17. Confocal laser scanning microscopy of SBP-PEG₄ modified surface (no RBD). Modified SERS substrates were immunolabeled with primary anti-RBD antibodies followed by alexa-488 anti-rabbit secondary antibodies. Scale bar 5 μm.

FIG. 18. Confocal laser scanning microscopy of SBP-PEG₄ surface after binding RBD. Modified SERS substrates were immunolabeled with primary anti-RBD antibodies followed by alexa-488 anti-rabbit secondary antibodies. Scale bars=5 μm.

FIG. 19. Confocal laser scanning microscopy 3D reconstructed side-view images of immunolabeled SERS surfaces modified with SBP-PEG₄ before and after RBD binding (scale bar=2 μm). Relative fluorescence is shown in FIG. 20.

FIG. 20. Relative fluorescence from quantification of integrated density from FIG. 19 of immunolabeled SER S surfaces modified with SBP-PEG₄ before and after RBD binding (n=4, area per n=156 μm²).

FIG. 21. SEM characterization of substrate modification. (Top row) SEM images of SERS substrates on edge to show pillars (scale bars=200 nm). (Bottom Row) SEM images of SERS substrates from top view to show aggregation of pillars after modification (scale bars=500 nm).

FIG. 22. Immunolabeled receptor binding domain SEM characterization. SEM image of SBP-PEG₄ modified SERS substrates after RBD binding and immunolabeling with 20 nm AuNP conjugated antibodies. Representative AuNPs indicated by red arrows. Scale bar=200 nm.

FIG. 23. Chemical structure and expected mass of Biotin-SBP peptide.

FIG. 24. Analytical HPLC (monitoring peptide absorbance at 214 nm) confirmed the Biotin-SBP peptide identity and high purity.

FIG. 25 ESI-MS confirmed the Biotin-SBP peptide identity and high purity.

FIG. 26. Chemical structure and expected mass of Biotin-SBP-PEG₄ peptide.

FIG. 27. Analytical HPLC (monitoring peptide absorbance at 214 nm) confirmed the Biotin-SBP-PEG₄ peptide identity and high purity.

FIG. 28. ESI-MS confirmed the Biotin-SBP-PEG₄ peptide identity and high purity.

FIG. 29. Biolayer interferometry binding curves for SBP peptides binding varying concentrations of SARS-CoV-2 RBD.

FIG. 30. Biolayer interferometry binding curves for SBP-PEG₄ peptides binding varying concentrations of SARS-CoV-2 RBD.

FIG. 31. Steady-state analysis of biolayer interferometry data to determine K_{d} values.

FIG. 32. Circular dichroism spectra of cysteine-modified peptides with and without a linker comparing the ability of each to form α-helical structures.

FIG. 33. Biolayer interferometry response of SBP-PEG₄ showing specific binding to RBD from SARS-CoV-2 compared to SARS-CoV-1 and MERS.

FIG. 34. Peptide Specificity. Biolayer interferometry kinetics curves for SBP-PEG₄ peptide binding specifically to SARS-CoV-2 RED compared to SARS-CoV-1 and MERS RED. Control line is kinetics buffer only.

FIG. 35. Characterization of substrate heat cleaning. SERS spectra of substrates before and after heat treatment.

FIG. 36. Characterization of substrate heat cleaning. XPS spectra before and after heating to 170° C. for 10 minutes.

FIG. 37. Atomic ratios derived from XPS spectra before and after heating (FIG. 36).

FIG. 38. Effect of backfilling on SERS spectra. SERS spectra before and after backfilling an SBP-PEG₄ modified substrate with 2-mercaptoethanol. The changes in the spectra are consistent with removing carbonaceous species.

FIG. 39. SERS spectra of the unmodified substrate and of both peptide-modified substrates before and after addition of 2 μM spike protein. The spectra are offset for clarity.

FIG. 40. Comparison of SERS signal from the SBP-PEG₄-modified surface and in the presence of 2 μM RBD and 2 μM full spike, with highlighted regions indicating important spectral similarities associated with the spike/RBD (maroon shading) and SBP-PEG₄ (teal shading). The spectra are offset for clarity.

FIG. 41. Specificity of the SBP-PEG₄ SERS sensor for SARS-CoV-2 receptor binding domain (blue) versus SARS-CoV-1 receptor binding domain (red) and MERS-CoV receptor binding domain (orange). The peptide surfaces (teal) prior to treatment with each receptor binding domain (RBD) (5 μM) are shown below each spectrum, respectively. The spectra are offset for clarity.

FIG. 42. Average spectra from the SBP-PEG₄-modified substrate treated with no protein, 15 M BSA, 2 μM spike, and 8 μM BSA plus 1 μM spike (8:1 mixture). The spectra are offset for clarity.

FIG. 43. Multivariate curve resolution (MCR) component 2, representing the SERS signature of the spike protein.

FIG. 44. Multivariate curve resolution (MCR) component 1, representing the SERS signature of the peptide.

FIG. 45. Multivariate curve resolution (MCR) scores on component 2 for the SBP-PEG₄-modified substrate with no protein, 15 μM BSA, 2 μM spike, and 8 μM BSA plus 1 μM spike (8:1 mixture). *p=0.05. ****p<0.001 FIG. 46. Multivariate curve resolution (MCR) scores on component 1 for the SPB-PEG₄-modified substrate with no protein, 8 μM BSA, 2 μM spike, and 8 μM BSA plus 1 μM spike (8:1 mixture).

FIG. 47. Average spectra (normalized to 1002 cm⁻¹) from the SBP-PEG₄-modified substrate treated with varying concentrations of spike protein. The spectra are offset for clarity.

FIG. 48. SERS-based calibration curve for the spike using multivariate curve resolution (MCR) scores on the spike component, showing a limit of detection of 300 nM.

FIG. 49. Average SERS spectra of spike protein at seven concentrations.

FIG. 50. Multivariate curve resolution (MCR) component representing SERS signature of spike protein.

FIG. 51. Multivariate curve resolution (MCR) scores for all 1200 spectra from each spike concentration.

FIG. 52. SERS-based calibration curve for SARS-CoV-2 spike protein on unmodified substrates based on average multivariate curve resolution (MCR) scores showing a limit of detection of 500 nM.

### DETAILED DESCRIPTION

The compositions, devices, methods, and systems described herein may be understood more readily by reference to the following detailed description of specific aspects of the disclosed subject matter and the Examples included therein.

Before the present compositions, devices, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

As used herein, by a “subject” is meant an individual. Thus, the “subject” can include domesticated animals (e.g., cats, dogs, etc.), livestock (e.g., cattle, horses, pigs, sheep, goats, etc.), laboratory animals (e.g., mouse, rabbit, rat, guinea pig, etc.), and birds. “Subject” can also include a mammal, such as a primate or a human. Thus, the subject can be a human or veterinary patient. The term “patient” refers to a subject under the treatment of a clinician, e.g., physician.

The term “inhibit” refers to a decrease in an activity, response, condition, disease, or other biological parameter. This can include but is not limited to the complete ablation of the activity, response, condition, or disease. This can also include, for example, a 10% reduction in the activity, response, condition, or disease as compared to the native or control level. Thus, the reduction can be a 10, 20, 30, 40, 50, 60, 70, 80, 90, 100%, or any amount of reduction in between as compared to native or control levels.

By “reduce” or other forms of the word, such as “reducing” or “reduction,” is meant lowering of an event or characteristic (e.g., tumor growth). It is understood that this is typically in relation to some standard or expected value, in other words it is relative, but that it is not always necessary for the standard or relative value to be referred to. For example, “reduces tumor growth” means reducing the rate of growth of a tumor relative to a standard or a control.

By “prevent” or other forms of the word, such as “preventing” or “prevention,” is meant to stop a particular event or characteristic, to stabilize or delay the development or progression of a particular event or characteristic, or to minimize the chances that a particular event or characteristic will occur. Prevent does not require comparison to a control as it is typically more absolute than, for example, reduce. As used herein, something could be reduced but not prevented, but something that is reduced could also be prevented. Likewise, something could be prevented but not reduced, but something that is prevented could also be reduced. It is understood that where reduce or prevent are used, unless specifically indicated otherwise, the use of the other word is also expressly disclosed. For example, the terms “prevent” or “suppress” can refer to a treatment that forestalls or slows the onset of a disease or condition or reduced the severity of the disease or condition. Thus, if a treatment can treat a disease in a subject having symptoms of the disease, it can also prevent or suppress that disease in a subject who has yet to suffer some or all of the symptoms.

The term “treatment” refers to the medical management of a patient with the intent to cure, ameliorate, stabilize, or prevent a disease, pathological condition, or disorder. This term includes active treatment, that is, treatment directed specifically toward the improvement of a disease, pathological condition, or disorder, and also includes causal treatment, that is, treatment directed toward removal of the cause of the associated disease, pathological condition, or disorder. In addition, this term includes palliative treatment, that is, treatment designed for the relief of symptoms rather than the curing of the disease, pathological condition, or disorder; preventative treatment, that is, treatment directed to minimizing or partially or completely inhibiting the development of the associated disease, pathological condition, or disorder; and supportive treatment, that is, treatment employed to supplement another specific therapy directed toward the improvement of the associated disease, pathological condition, or disorder.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning.

The term “machine learning” is defined herein to be a subset of Al that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or target) during training with a labeled data set (or dataset). In an unsupervised learning model, the model learns a function that maps an input (also known as feature or features) to an output (also known as target or target) during training with an unlabeled data set. In a semi-supervised model, the model learns a function that maps an input (also known as feature or features) to an output (also known as target or target) during training with both labeled and unlabeled data.

### Chemical Definitions

Unless otherwise defined, all technical and scientific terms used herein have the same meaning as commonly understood by one of ordinary skill in the art to which this invention belongs.

The organic moieties mentioned when defining variable positions within the general formulae described herein (e.g., the term “halogen”) are collective terms for the individual substituents encompassed by the organic moiety. The prefix Cₙ-Cₘ preceding a group or moiety indicates, in each case, the possible number of carbon atoms in the group or moiety that follows.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“Z¹,” “Z²,” “Z³,” and “Z⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” as used herein refers to a non-aromatic hydrocarbon group and includes branched and unbranched, alkyl, alkenyl, or alkynyl groups.

As used herein, the term “alkyl” refers to saturated, straight-chained or branched saturated hydrocarbon moieties. Unless otherwise specified, C₁-C₂₄ (e.g., C₁-C₂₂, C₁-C₂₀, C₁-C₁₈, C₁-C₁₆, C₁-C₄, C₁-C₁₂, C₁-C₁₀, C₁-C₈, C₁-C₆, or C₁-C₄) alkyl groups are intended. Examples of alkyl groups include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, I-ethyl-butyl, 2-ethyl-butyl, 1,1,2-trimethyl-propyl, 1,2,2-trimethyl-propyl, 1-ethyl-1-methyl-propyl, 1-ethyl-2-methyl-propyl, heptyl, octyl, nonyl, decyl, dodecyl, tetradecyl, hexadecyl, eicosyl, tetracosyl, and the like. Alkyl substituents may be unsubstituted or substituted with one or more chemical moieties. The alkyl group can be substituted with one or more groups including, but not limited to, hydroxyl, halogen, acetal, acyl, alkyl, alkoxy, alkenyl, alkynyl, aryl, heteroaryl, aldehyde, amino, cyano, carboxylic acid, ester, ether, carbonate ester, carbamate ester, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halides (halogens; e.g., fluorine, chlorine, bromine, or iodine). The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

As used herein, the term “alkenyl” refers to unsaturated, straight-chained, or branched hydrocarbon moieties containing a double bond. Unless otherwise specified, C₂-C₂₄ (e.g., C₂-C₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, I-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-5 butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl−1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl. 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl−1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl−1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C Alkenyl substituents may be unsubstituted or substituted with one or more chemical moieties. Examples of suitable substituents include, for example, alkyl, alkoxy, alkenyl, alkynyl, aryl, heteroaryl, acetal, acyl, aldehyde, amino, cyano, carboxylic acid, ester, ether, carbonate ester, carbamate ester, halide, hydroxyl, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

As used herein, the term “alkynyl” represents straight-chained or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, I-methyl-2-butynyl, 1-methyl-3-butynyl, 2-methyl-3-butynyl, 1,1-dimethyl-2-propynyl, 1-ethyl-2-propynyl, I-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. Alkynyl substituents may be unsubstituted or substituted with one or more chemical moieties. Examples of suitable substituents include, for example, alkyl, alkoxy, alkenyl, alkynyl, aryl, heteroaryl, acetal, acyl, aldehyde, amino, cyano, carboxylic acid, ester, ether, carbonate ester, carbamate ester, halide, hydroxyl, ketone, nitro, phosphonyl, silyl, sulfo-oxo, sulfonyl, sulfone, sulfoxide, or thiol, as described below.

As used herein, the term “aryl,” as well as derivative terms such as aryloxy, refers to groups that include a monovalent aromatic carbocyclic group of from 3 to 50 carbon atoms. Aryl groups can include a single ring or multiple condensed rings. In some embodiments, aryl groups include C₆-C₁₀ aryl groups. Examples of aryl groups include, but are not limited to, benzene, phenyl, biphenyl, naphthyl, tetrahydronaphthyl, phenylcyclopropyl, phenoxybenzene, and indanyl. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. The term “non-heteroaryl,” which is also included in the term “aryl,” defines a group that contains an aromatic group that does not contain a heteroatom. The aryl substituents may be unsubstituted or substituted with one or more chemical moieties. Examples of suitable substituents include, for example, alkyl, alkoxy, alkenyl, alkynyl, aryl, heteroaryl, acetal, acyl, aldehyde, amino, cyano, carboxylic acid, ester, ether, carbonate ester, carbamate ester, halide, hydroxyl, ketone, nitro, phosphonyl, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, acetal, acyl, aldehyde, amino, cyano, carboxylic acid, ester, ether, carbonate ester, carbamate ester, halide, hydroxyl, ketone, nitro, phosphonyl, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, acetal, acyl, aldehyde, amino, cyano, carboxylic acid, ester, ether, carbonate ester, carbamate ester, halide, hydroxyl, ketone, nitro, phosphonyl, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems (e.g., monocyclic, bicyclic, tricyclic, polycyclic, etc.) that can be substituted or unsubstituted. A cyclic group can contain one or more aryl groups, one or more non-aryl groups, or one or more aryl groups and one or more non-aryl groups.

The term “acyl” as used herein is represented by the formula —C(O)Z¹ where Z¹ can be a hydrogen, hydroxyl, alkoxy, alkyl, alkenyl, alkynyl, aryl, heteroaryl, cycloalkyl, cycloalkenyl, heterocycloalkyl, or heterocycloalkenyl group described above. As used herein, the term “acyl” can be used interchangeably with “carbonyl.” Throughout this specification “C(O)” or “CO” is a shorthand notation for C═O.

The term “acetal” as used herein is represented by the formula (Z¹Z²)C(═OZ³)(═OZ⁴), where Z¹, Z², Z³, and Z⁴ can be, independently, a hydrogen, halogen, hydroxyl, alkyl, alkenyl, alkynyl, aryl, heteroaryl, cycloalkyl, cycloalkenyl, heterocycloalkyl, or heterocycloalkenyl group described above.

The term “alkanol” as used herein is represented by the formula Z¹OH, where Z¹ can be an alkyl, alkenyl, alkynyl, aryl, heteroaryl, cycloalkyl, cycloalkenyl, heterocycloalkyl, or heterocycloalkenyl group described above.

As used herein, the term “alkoxy” as used herein is an alkyl group bound through a single, terminal ether linkage; that is, an “alkoxy” group can be defined as to a group of the formula Z¹—O—, where Z¹ is unsubstituted or substituted alkyl as defined above. Unless otherwise specified, alkoxy groups wherein Z¹ is a C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-pentoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl−1-methyl-propoxy, and 1-ethyl-2-methyl-propoxy.

The term “aldehyde” as used herein is represented by the formula —C(O)H. Throughout this specification “C(O)” is a shorthand notation for C═O.

The terms “amine” or “amino” as used herein are represented by the formula —NZ²Z³, where Z¹, Z², and Z³ can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The terms “amide” or “amido” as used herein are represented by the formula —C(O)NZ¹Z², where Z¹ and Z² can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The term “anhydride” as used herein is represented by the formula Z¹C(O)OC(O)Z² where Z¹ and Z², independently, can be an alkyl, alkenyl, alkynyl, aryl, heteroaryl, cycloalkyl, cycloalkenyl, heterocycloalkyl, or heterocycloalkenyl group described above.

The term “cyclic anhydride” as used herein is represented by the formula:

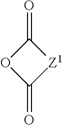

where Z¹ can be an alkyl, alkenyl, alkynyl, aryl, heteroaryl, cycloalkyl, cycloalkenyl, heterocycloalkyl, or heterocycloalkenyl group described above.

The term “azide” as used herein is represented by the formula —N═N═N.

The term “carboxylic acid” as used herein is represented by the formula —C(O)OH.

A “carboxylate” or “carboxyl” group as used herein is represented by the formula —C(O)O⁻.

A “carbonate ester” group as used herein is represented by the formula Z¹OC(O)OZ².

The term “cyano” as used herein is represented by the formula —CN.

The term “ester” as used herein is represented by the formula —OC(O)Z¹ or —C(O)OZ¹, where Z¹ can be an alkyl, alkenyl, alkynyl, aryl, heteroaryl, cycloalkyl, cycloalkenyl, heterocycloalkyl, or heterocycloalkenyl group described above.

The term “ether” as used herein is represented by the formula Z¹OZ², where Z¹ and Z² can be, independently, an alkyl, alkenyl, alkynyl, aryl, heteroaryl, cycloalkyl, cycloalkenyl, heterocycloalkyl, or heterocycloalkenyl group described above.

The term “epoxy” or “epoxide” as used herein refers to a cyclic ether with a three atom ring and can represented by the formula:

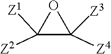

where Z¹, Z², Z³, and Z⁴ can be, independently, an alkyl, alkenyl, alkynyl, aryl, heteroaryl, cycloalkyl, cycloalkenyl, heterocycloalkyl, or heterocycloalkenyl group described above.

The term “ketone” as used herein is represented by the formula Z¹C(O)Z², where Z¹ and Z² can be, independently, an alkyl, alkenyl, alkynyl, aryl, heteroaryl, cycloalkyl, cycloalkenyl, heterocycloalkyl, or heterocycloalkenyl group described above.

The term “halide” or “halogen” or “halo” as used herein refers to fluorine, chlorine, bromine, and iodine.

The term “hydroxyl” as used herein is represented by the formula —OH.

The term “nitro” as used herein is represented by the formula —NO₂.

The term “phosphonyl” is used herein to refer to the phospho-oxo group represented by the formula —P(O)(OZ¹)₂, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “silyl” as used herein is represented by the formula SiZ¹Z²Z³, where Z¹, Z² and Z³ can be, independently, hydrogen, alkyl, alkoxy, alkenyl, alkynyl, aryl, heteroaryl, cycloalkyl, cycloalkenyl, heterocycloalkyl, or heterocycloalkenyl group described above.

The term “sulfonyl” or “sulfone” is used herein to refer to the sulfo-oxo group represented by the formula —S(O)₂Z¹, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “sulfide” as used herein is comprises the formula —S—.

The term “thiol” as used herein is represented by the formula —SH.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

Unless stated to the contrary, a formula with chemical bonds shown only as solid lines and not as wedges or dashed lines contemplates each possible stereoisomer or mixture of stereoisomer (e.g., each enantiomer, each diastereomer, each meso compound, a racemic mixture, or scalemic mixture).

### Assays

Disclosed herein are compositions, devices, systems, and methods for detection of a target virus via Surface Enhanced Raman Spectroscopy (SERS) using a peptide-modified nanostructured metal.

For example, disclosed herein are assays for detection of a target virus via Surface Enhanced Raman Spectroscopy (SERS), the assay comprising: a peptide-modified nanostructured metal comprising a nanostructured metal having a first plurality of peptides attached to a surface thereof, wherein each of the first plurality of peptides comprises a capture portion configured to capture and bind with at least a first portion of the target virus, and wherein the surface of the nanostructured metal is configured to enhance a Raman signal of at least a second portion of the target virus bound to the capture portion of one or more of the first plurality of peptides. The first portion of the target virus and the second portion of the target virus can be the same or different. In some examples, the first plurality of peptides are attached to the surface of the nanostructured metal substantially homogeneously across the surface of said nanostructured metal.

As used herein, “nanostructured” means any structure with one or more nanosized features. A nanosized feature can be any feature with at least one dimension less than 1 micrometer (μm) in size. For example, a nanosized feature can comprise a nanowire, nanotube, nanoparticle, nanopore, and the like, or combinations thereof. As such, the nanostructured metal can comprise, for example, a nanowire, nanotube, nanoparticle, nanopore, or a combination thereof. In some examples, the nanostructured metal can comprise a metal that is not nanosized but has been modified with a nanowire, nanotube, nanoparticle, nanopore, or a combination thereof.

The nanostructured metal can comprise any metal suitable for Surface Enhanced Raman Spectroscopy (SERS). The nanostructured metal can comprise, for example, a metal selected from the group consisting of Ru, Rh, Pd, Os, Ir, Pt, Au, Ag, Cu, Al, and combinations thereof. In some examples, the nanostructured metal comprises a metal selected from the group consisting of Pt, Au, Ag, Cu, Al, and combination thereof. In some examples, the nanostructured metal comprises a metal selected from the group consisting of Au, Ag, and combinations thereof.

In some examples, the nanostructured metal comprises a metal modified with a nanostructure, such as a metal film or layer with one or more nanosized features.

In some examples, the nanostructured metal comprises a plurality of metal particles. In some examples, the assay comprises a plurality of peptide-modified metal particles, wherein each of the plurality of peptide-modified metal particles comprises a metal particle having a portion of the first plurality of peptides attached to a surface thereof.

The plurality of metal particles can comprise particles of any shape, such as a polyhedron (e.g., a platonic solid, a prism, a pyramid), a stellated polyhedron (e.g., a star), a cylinder, a hemicylinder, an elliptical cylinder, a hemi-elliptical cylinder, a sphere, a hemisphere, a cone, a semicone, etc. In some examples, the plurality of metal particles can have a regular shape, an irregular shape, an isotropic shape, an anisotropic shape, or a combination thereof. In some examples, the plurality of metal particles can have an isotropic shape or an anisotropic shape. In some examples, the plurality of metal particles can be have a shape that is substantially spherical, rod-like, pillar-like, or star-like.

The plurality of metal particles can have an average particle size. “Average particle size” and “mean particle size” are used interchangeably herein, and generally refer to the statistical mean particle size of the particles in a population of particles. For example, the average particle size for a plurality of particles with a substantially spherical shape can comprise the average diameter of the plurality of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. Mean particle size can be measured using methods known in the art, such as evaluation by scanning electron microscopy, transmission electron microscopy, and/or dynamic light scattering.

The plurality of metal particles can, for example, have an average particle size of 5 nanometers (nm) or more (e.g., 10 nm or more, 15 nm or more, 20 nm or more, 2.5 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, or 900 nm or more). In some examples, the plurality of metal particles can have an average particle size of 1 micrometer (micron, μm) or less (e.g., 900 nm or less, 800 nm or less, 700 nm or less, 600 nm or less, 500 nm or less, 450 nm or less, 400 nm or less, 350 nm or less, 300 nm or less, 250 am or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, or 10 nm or less). The average particle size of the plurality of metal particles can range from any of the minimum values described above to any of the maximum values described above. For example, the plurality of metal particles have an average particle size of from 5 nanometers (am) to 1 micrometer (micron, μm) (e.g., from 5 nm to 500 nm, from 500 nm to 1 μm, from 5 nm to 200 nm, from 200 nm to 400 nm, from 400 nm to 600 nm, from 600 nm to 800 nm, from 800 nm to 1 μm, from 10 nm to 1 μm, from 5 nm to 900 nm, from 10 nm to 900 nm, from 5 nm to 400 nm, or from 20 nm to 200 nm).

In some examples, the plurality of metal particles can be substantially monodisperse. “Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the median particle size (e.g., within 20% of the median particle size, within 15% of the median particle size, within 10% of the median particle size, or within 5% of the median particle size).

In some examples, the plurality of peptide-modified particles are at least partially dispersed in a solvent (e.g., a colloidal dispersion). The solvent can, for example, comprise water, ethylene glycol, polyethylene glycol, glycerol, alkane diol, ethanol, methanol, propanol, isopropanol, dimethyl sulfoxide (DMSO), acetonitrile, methylene chloride, or combinations thereof. In some examples, the solvent comprises water (e.g., an aqueous colloidal dispersion).

In some examples, the plurality of peptide-modified particles are disposed on a substrate. Examples of substrates include, but are not limited to, glass, quartz, silicon, silicon dioxide, nitrides (e.g., silicon nitride), polycarbonate, polydimethylsiloxane (PDMS), a cellulosic/lignin based substrate (e.g., wood, paper (such as chromatography paper), etc.), and combinations thereof.

In some examples, the surface of the nanostructured further comprises a plurality of ligands attached thereto. For example, the plurality of ligands can comprise a short chain thiol, e.g. a C₁-C₆ aliphatic thiol optionally substituted with one or more additional substituents, such as 2-mercaptoethanol. In some examples, the plurality of ligands comprise a second plurality of peptides.

In some examples, the peptide-modified nanostructured metal comprises a first population and a second population, the first population being modified with the first plurality of peptides and the second population being modified with the second plurality of peptides.

In some examples, assay comprises a plurality of peptide-modified metal particles, the plurality of peptide-modified metal particles comprising a first population of metal particles modified with the first plurality of peptides and a second population of metal particles modified with the second plurality of peptides (e.g., each metal particle is modified with only the first peptide or the second peptide).

In some examples, each of the second plurality of peptides has a binding portion configured to capture and bind to at least a first portion of a second target virus.

For example, also disclosed herein are assays for detection of a first target virus and a second target virus via Surface Enhanced Raman Spectroscopy (SEES), the assay comprising: a peptide-modified nanostructured metal comprising a nanostructured metal having a first plurality of peptides and a second plurality of peptides attached to a surface thereof, wherein each of the first plurality of peptides comprises a capture portion configured to capture and bind with at least a first portion of the first target virus, wherein each of the second plurality of peptides comprises a binding portion configured to capture and bind with a least a first portion of the second target virus, wherein the surface of the nanostructured metal is configured to enhance a Raman signal of at least a second portion of the first target virus bound to the capture portion of one or more of the first plurality of peptides, and wherein the surface of the nanostructured metal is configured to enhance a Raman signal of at least a second portion of the second target virus bound to the binding portion of one or more of the second plurality of peptides.

Also disclosed herein, for example, are assays for detection of a first target virus and a second target virus via Surface Enhanced Raman Spectroscopy (SERS), the assay comprising: a first peptide-modified nanostructured metal comprising a first nanostructured metal having a first plurality of peptides attached to a surface thereof, a second peptide-modified nanostructured metal comprising a second nanostructured metal having a second plurality of peptides attached to a surface thereof, wherein each of the first plurality of peptides comprises a capture portion configured to capture and bind with at least a first portion of the first target virus, wherein each of the second plurality of peptides comprises a binding portion configured to capture and bind with a least a first portion of the second target virus, wherein the surface of the first nanostructured metal is configured to enhance a Raman signal of at least a second portion of the first target virus bound to the capture portion of one or more of the first plurality of peptides, and wherein the surface of the second nanostructured metal is configured to enhance a Raman signal of at least a second portion of the second target virus bound to the binding portion of one or more of the second plurality of peptides.

In some examples, the second target virus is different than the first target virus. In some examples, the first target virus is a first variant of a virus and the second target virus is a second variant of the virus, the first variant being different than the second variant.

In some examples, each of the first plurality of peptides further includes a first spacer portion, the first spacer portion being adjacent the capture portion and configured to space the capture portion away from the surface of the nanostructured metal. In some examples, the first spacer portion comprises a substituted or unsubstituted aliphatic chain, an amino acid, a third peptide, or a combination thereof. In some examples, the first spacer portion comprises poly(ethylene glycol) (PEG), such as PEG₄.

The first spacer portion can, for example, have an average length of 1 nm or more (e.g., 1.5 nm or more, 2 nm or more, 2.5 nm or more, 3 nm or more, 3.5 nm or more, 4 nm or more, 4.5 nm or more, 5 nm or more, 5.5 nm or more, 6 nm or more, 6.5 nm or more, 7 nm or more, 7.5 nm or more, 8 nm or more, 8.5 nm or more, or 9 nm or more). In some examples, the first spacer portion can have an average length of 10 nm or less (e.g., 9.5 nm or less, 9 nm or less, 8.5 nm or less, 8 nm or less, 7.5 nm or less, 7 nm or less, 6.5 nm or less, 6 nm or less, 5.5 nm or less, 5 nm or less, 4.5 nm or less, 4 nm or less, 3.5 nm or less, 3 nm or less, 2.5 nm or less, 2 nm or less, or 1.5 nm or less). The average length of the first spacer portion can range from any of the minimum values described above to any of the maximum values described above. For example, the first spacer portion can have an average length of from 1 nm to 10 nm (e.g., from 1 nm to 5 nm, from 5 nm to 10 nm, from 1 nm to 2 nm, from 2 nm to 4 nm, from 4 urn to 6 nm, from 6 nm to 8 nm, from 8 nm to 10 nm, from 2 nm to 10 nm, from 1 nm to 9 nm, or from 2 nm to 9 nm). The average length of the first spacer portion can be selected in view of a variety of factors. For example, the average length of the first spacer portion can be selected to improve the binding affinity of the target virus with the capture portion.

In some examples, each of the second plurality of peptides further includes a second spacer portion, the second spacer portion being adjacent the binding portion and configured to space the binding portion away from the surface of the nanostructured metal. In some examples, the second spacer portion comprises a substituted or unsubstituted aliphatic chain, an amino acid, a third peptide, or a combination thereof.

The second spacer portion can, for example, have an average length of 1 nm or more (e.g., 1.5 nm or more, 2 nm or more, 2.5 nm or more, 3 nm or more, 3.5 nm or more, 4 nm or more, 4.5 nm or more, 5 nm or more, 5.5 nm or more, 6 nm or more, 6.5 nm or more, 7 nm or more, 7.5 nm or more, 8 nm or more, 8.5 nm or more, or 9 nm or more). In some examples, the second spacer portion can have an average length of 10 nm or less (e.g., 9.5 nm or less, 9 nm or less, 8.5 nm or less, 8 nm or less, 7.5 nm or less, 7 nm or less, 6.5 nm or less, 6 nm or less, 5.5 nm or less, 5 nm or less, 4.5 nm or less, 4 nm or less, 3.5 nm or less, 3 nm or less, 2.5 nm or less, 2 nm or less, or 1.5 nm or less). The average length of the second spacer portion can range from any of the minimum values described above to any of the maximum values described above. For example, the second spacer portion can have an average length of from 1 nm to 10 nm (e.g., from 1 nm to 5 nm, from 5 nm to 10 nm, from 1 nm to 2 nm, from 2 nm to 4 nm, from 4 nm to 6 nm, from 6 nm to 8 nm, from 8 nm to 10 nm, from 2 nm to 10 nm, from 1 nm to 9 nm, or from 2 nm to 9 nm). The average length of the second spacer portion can be selected in view of a variety of factors. For example, the average length of the second spacer portion can be selected to improve the binding affinity of the second target virus with the binding portion.

In some examples, the first plurality of peptides and/or the second plurality of peptides independently further comprise(s) a SERS reporter, such as those known in the art. Examples of suitable SERS reporters include, but are not limited to, organic dyes, organic molecules, metal particles, and combinations thereof.

In some examples, the first portion of the (first) target virus and/or the second target virus comprises a viral protein. In some examples, the first portion of the (first) target virus and/or the second target virus is a surface protein.

The (first) target virus and/or the second target virus can comprise any virus of interest. Viruses that are suitable for the assays, methods, devices, and uses described herein can include both DNA viruses and RNA viruses. Exemplary viruses can belong to the following non-exclusive list of families Adenoviridae, Arenaviridae, Astroviridae, Baculoviridae, Barnaviridae, Betaherpesvirinae, Birnaviridae, Bromoviridae, Bunyaviridae, Caliciviridae, Chordopoxvirinae, Circoviridae, Comoviridae, Coronaviridae, Cystoviridae, Corticoviridae, Entomnopoxvirinae, Filoviridae, Flaviviridae, Fuselloviridae, Geminiviridae, Hepadnaviridae, Herpesviridae, Gaimmaherpesvirinae, Inoviridae, Iridoviridae, Leviviridae, Lipothrixviridae, Microviridae, Myoviridae, Nodaviridae, Orthomyxoviridae, Papovaviridae, Paramyxoviridae, Paramyxovirinae, Partitiviridae, Parvoviridae, Phycodnaviridae, Picornaviridae, Plasmaviridae, Pneumovirinae, Podoviridae, Polydnaviridae, Potyviridae, Poxviridae, Reoviridae, Retroviridae, Rhabdoviridae, Sequiviridae, Siphoviridae, Tectiviridae, Tetraviridae, Togaviridae, Tombusviridae, and Totiviridae.

Specific examples of viruses include, but are not limited to, Mastadenovirus, Adenovirus, Human adenovirus 2, Aviadenovirus, African swine fever virus, classical swine fever virus, arenavirus, Lymphocytic choriomeningitis virus, Ippy virus, Lassa virus, Arterivirus, Human astrovirus 1, Nucleopolyhedrovirus, Autographa californica nucleopolyhedrovirus, Granulovirus, Phodia interpunctella granulovirus, Badnavirus, Commelina yellow mottle virus, Rice tungro bacilliform, Barnavirus, Mushroom bacilliform virus, Aquabirnavirus, Infectious pancreatic necrosis virus, Avibirnavinis, Infectious bursal disease virus, Entomobirnavirus, Drosophila X virus, Alfamovirus, Alfalfa mosaic virus, Ilarvirus, Ilarvirus Subgroups 1-10, Tobacco streak virus, Bromovirus, Brome mosaic virus, Cucumovirus, Cucumber mosaic virus, Bhanja virus Group, Kaisodi virus, Mapputta virus, Okola virus, Resistencia virus, Upolu virus, Yogue virus, Bunyavirus, Anopheles A virus, Anopheles B virus, Bakau virus, Bunyamwera virus, Bwamba virus, C virus, California encephalitis virus, Capim virus, Gamboa virus, Guama virus, Koongol virus, Minatitlan virus, Nyando virus, Olifantsvlei virus, Patois virus, Simbu virus, Tete virus, Turlock virus, Hantavirus, Hantaan virus, Nairovirus, Crimean-Congo hemorrhagic fever virus, Dera Ghazi Khan virus, Hughes virus, Nairobi sheep disease virus, Qalyub virus, Sakhalin virus, Thiafora virus, Crimean-congo hemorrhagic fever virus, Phlebovirus, Sandfly fever virus, Bujaru complex, Candiru complex, Chilibre complex, Frijoles complex, Punta Toro complex, Rift Valley fever complex, Salehabad complex, Sandfly fever Sicilian virus, Uukuniemi virus, Uukuniemi virus, Tospovirus, Tomato spotted wilt virus, Calicivirus, Vesicular exanthema of swine virus, Capillovirus, Apple stem grooving virus, Carlavirus, Carnation latent vinis, Caulimovirus, Cauliflower mosaic virus, Circovirus, Chicken anemia virus, Closterovirus, Beet yellows virus, Comovirus, Cowpea mosaic virus, Fabavirus, Broad bean wilt virus 1, Nepovirus, Tobacco ringspot virus, Coronavirus, Avian infectious bronchitis virus, Bovine coronavirus, Canine coronavirus, Feline infectious peritonitis virus, Human coronavirus 299E, Human coronavirus OC43, Murine hepatitis virus, Porcine epidemic diarrhea virus, Porcine hemagglutinating encephalomyelitis virus, Porcine transmissible gastroenteritis virus, porcine reproductive and respiratory syndrome virus, Rat coronavirus, Turkey coronavirus, Rabbit coronavirus, Torovirus, Berne virus, Breda virus, Corticovirus, Alteromonas phage PM2, Pseudomonas Phage phi6, Deltavirus, Hepatitis delta virus, Hepatitis) virus, Hepatitis E virus, Dianthovirus, Carnation ringspot virus, Red clover necrotic mosaic virus, Sweet clover necrotic mosaic virus, Enamovirus, Pea enation mosaic virus, Filovirus, Marburg virus, Ebola virus, Ebola virus Zaire, Flavivirus, Yellow fever virus, Tick-borne encephalitis virus, Rio Bravo Group, Japanese encephalitis, Tyuleniy Group, Ntaya Group, Uganda S Group, Dengue Group, Modoc Group, Pestivirus, Bovine diarrhea virus, Hepatitis C virus, Furovirus, Soil-borne wheat mosaic virus, Beet necrotic yellow vein virus, Fusellovirus, Sulfobolus virus 1, Subgroup 1, II, and III geminivirus. Maize streak virus, Beet curly top virus, Bean golden mosaic virus, Orthohepadnavirus, Hepatitis B virus, Avihepadnavirus, Alphaherpesvirinae, Sinplexvirus, Human herpesvirus 1, Herpes Simplex virus-1, Herpes Simplex virus-2, Varicellovirus, Varicella-Zoster virus, Epstein-Barr virus, Human herpesvirus 3, Cytomnegalovirus, Human herpesvirus 5, Muromegalovirus, Mouse cytomegalovirus 1, Roseolovirus, Human herpesvirus 6, Lymphocryptovirus, Human herpesvirus 4, Rhadinovirus, Ateline herpesvirus 2, Hordeivirus, Barley stripe mosaic virus, Hlypoviridae, Hypovirus, Cryphonectria hypovirus 1-EP713, Idaeovirus, Raspberry bushy dwarf virus, Inovirus, Coliphage fd, Plectrovirus, Acholeplasma phage L51, Iridovirus, Chilo iridescent virus, Chiloriridovirus, Mosquito iridescent virus, Ranavirus, Frog virus 3, Lymphocystivirus, Lymphocystis disease virus flounder isolate, Goldfish virus 1, Levivirus, Enterobacteria phage MS2, Allolevirus, Enterobacteria phage Qbeta, Lipothrixvirus, Thermoproteus virus 1, Luteovirus, Barley yellow dwarf virus, Machlomovirus, Maize chlorotic mottle virus, Marafivirus, Maize rayado fino virus, Microvirus, Coliphage phiX174, Spiromicrovirus, Spiroplasma phage 4, Bdellomicrovirus, Bdellovibrio phage MAC 1, Chlamydiamicrovirus, Chlanydia phage 1, T4-like phages, coliphage T4, Necrovirus, Tobacco necrosis virus, Nodavirus, Nodamura virus, Influenzavirus A, B and C, Thogoto virus, Polyomavirus, Murine polyomavirus, Papillomavirus, Rabbit (Shope) Papillomavirus, Paramyxovirus, Human parainfluenza virus 1, Morbillivirus, Measles virus, Rubulavirus, Mumps virus, Pneumovirus, Human respiratory syncytial virus, Partitivirus, Gaeumannomyces graminis virus 019/6-A, Chrysovirus, Penicillium chrysogenum virus, Alphacryptovirus, White clover cryptic viruses 1 and 2, Betacryptovirus, Parvovirinae, Parvovirus, Minute mice virus, Erythrovirus, B19 virus, Dependovirus, Adeno-associated virus 1, Densovirinae, Densovirus, Junoma coenia densovirus, Iteravirus, Bombyx mori virus, Contravirus, Aedes aegypti densovirus, Phycodnavirus, 1-Paranmeciurn bursaria Chlorella NC64A virus group, Parameciurn bursaria chlorella virus 1, 2-Paramecium bursaria Chlorella Pbi virus, 3-Hydra viridis Chlorella virus, Enterovirus, Poliovirus, Hunman poliovirus 1, Rhinovirus, Hunman rhinovirus 1A, Hepatovirus, Fluman hepatitis A virus, Cardiovirus, Encephalomyocarditis virus, Aphthovirus, Foot-and-mouth disease virus, Plasmavirus, Acholeplasma phage L2, Podovirus, Coliphage T7, Ichnovirus, Campoletis sonorensis virus, Bracovirus, Cotesia melanoscela virus, Potexvirus, Potato virus X, Potyvirus, Potato virus Y, Rymovirus, Ryegrass mosaic virus, Bymovirus, Barley yellow mosaic virus, Orthopoxvirus, Vaccinia virus, Parapoxvirus, Orf virus, Avipoxvirus, Fowlpox virus, Capripoxvirus, Sheep pox virus, Leporipoxvirus, Myxoma virus, Suipoxvirus, Swinepox virus, Molluscipoxvirus, Molluscum contagiosum virus, Yatapoxvirus, Yaba monkey tumor virus, Entomopoxviruses A, B, and C, Melokontha melolontha entomopoxvirus, Amsacta moorei entomopoxvirus, Chironomus luridus entomopoxvirus, Orthoreovirus, Mammalian orthoreoviruses, reovirus 3, Avian orthoreoviruses, Orbivirus, African horse sickness viruses 1, Bluetongue viruses 1, Changuinola virus, Corriparta virus, Epizootic hemorrhagic disease virus 1, Equine encephalosis virus, Eubenangee virus group, Lebombo virus, Orungo virus, Palyam virus, Umatilla virus, Wallal virus, Warrego virus, Kemerovo virus, Rotavirus, Groups A-F rotaviruses, Simian rotavirus SA11, Coltivirus, Colorado tick fever virus, Aquareovirus, Groups A-E aquareoviruses, Golden shiner virus, Cypovirus, Cypovirus types 1-12, Bombyx mori cypovirus 1, Fijivirus, Fijivirus groups 1-3, Fiji disease virus, Fijivirus groups 2-3, Phytoreovirus, Wound tumor virus, Oryzavirus, Rice ragged stunt, Mammalian type B retroviruses, Mouse mammary tumor virus, Mammalian type C retroviruses, Murine Leukemia Virus, Reptilian type C oncovirus, Viper retrovirus, Reticuloendotheliosis virus, Avian type C retroviruses, Avian leukosis virus, Type D Retroviruses, Mason-Pfizer monkey virus, BLV-HTLV retroviruses, Bovine leukemia virus, Lentivirus, Bovine lentivirus, Bovine immunodeficiency virus, Equine lentivirus, Equine infectious anemia virus, Feline lentivirus, Feline immunodeficiency virus, Canine immunodeficiency virus Ovine/caprine lentivirus, Caprine arthritis encephalitis virus, Visna/maedi virus, Primate lentivirus group, Human immunodeficiency virus 1, Human immunodeficiency virus 2, Human immunodeficiency virus 3, Simian immunodeficiency virus, Spumavirus, Human spuma virus, Vesiculovirus, Vesicular stomatitis virus, Vesicular stomatitis Indiana virus, Lyssavirus, Rabies virus, Ephemerovirus, Bovine ephemeral fever virus, Cytorhabdovirus, Lettuce necrotic yellows virus, Nucleorhabdovirus, Potato yellow dwarf virus, Rhizidiovirus, Rhizidiomyces virus, Sequivirus, Parsnip yellow fleck virus, Waikavirus, Rice tungro spherical virus, Lambda-like phages, Coliphage lambda, Sobemovirus, Southern bean mosaic virus, Tectivirus, Enterobacteria phage PRD1, Tenuivirus, Rice stripe virus, Nudaurelia capensis beta-like viruses, Nudaurelia beta virus, Nudaurelia capensis omega-like viruses, Nudaurelia onega virus, Tobamovirus, Tobacco mosaic virus (vulgare strain; ssp. NC82 strain), Tobravirus, Tobacco rattle virus, Alphavirus, Sindbis virus, Rubivirus, Rubella virus, Tombusvirus, Tomato bushy stunt, virus, Carmovirus, Carnation mottle virus, Turnip crinkle virus, Totivirus, Saccharomyces cerevisiae virus, Giardiavirus, Giardia lamblia virus, Leishmaniavirus, Leishmania brasiliensis virus 1-1, Trichovirus, Apple chlorotic leaf spot virus, Tymovirus, Turnip yellow mosaic virus, Umbravirus, Carrot mottle virus, Variola virus, Coxsackie virus, Dengue virus, Rous sarcoma virus, Zika virus, Lassa fever virus, Eastern Equine Encephalitis virus, Venezuelan equine encephalitis virus, Western equine encephalitis virus, St. Louis Encephalitis virus, Murray Valley fever virus, West Nile virus, Human T-cell Leukemia virus type-1, echovirus, norovirus, and feline calicivirus (FCV).

In some examples, the (first) target virus and/or the second target virus can independently comprise an influenza virus, a coronavirus, or a combination thereof. Examples of influenza viruses include, but are not limited to, Influenzavirus A (including the H1N1, H2N2, H3N2, H5N1, H7N7, H1N2, H9N2, H7N2, H7N3, H10N7, H7N9, and H6N1 serotypes), Influenzavirus B, Influenzavirus C, and Influenzavirus D. Examples of coronaviruses include, but are not limited to, avian coronavirus (IBV), porcine epidemic diarrhea virus (PEDV), porcine respiratory coronavirus (PRCV), porcine reproductive and respiratory syndrome (PRRS) virus, transmissible gastroenteritis virus (TGEV), feline coronavirus (FCoV), feline infectious peritonitis virus (FIV), feline enteric coronavirus (FECV), canine coronavirus (CCoV), rabbit coronavirus (RaCoV), mouse hepatitis virus (MI-H), rat coronavirus (RCoV), sialodacryadenitis virus of rats (SDAV), bovine coronavirus (BCoV), bovine enterovirus (BEV), porcine coronavirus HKU15 (PorCoV HKU15), Porcine epidemic diarrhea virus (PEDV), porcine hemagglutinating encephalomvelitis virus (HEV), turkey bluecomb coronavirus (TCoV), human coronavirus (HCoV)-229E, HCoV-OC43, HCoV-HKU1, HCoV-NL63, Severe Acute Respiratory Syndrome (SARS)-Coronavirus (CoV)(SARS-CoV), Severe Acute Respiratory Syndrome (SARS)-Coronavirus (CoV)-2 (SARS-CoV-2), and middle east respiratory syndrome (MQERS) coronavirus (CoV) (MERS-CoV).

In some examples, the (first) target virus can comprise Severe Acute Respiratory Syndrome (SARS)-Coronavirus (CoV)-2 (SARS-CoV-2). In some examples, the target virus comprises one or more variants of SARS-CoV-2. In some examples, the second target virus can comprise an influenza virus, a coronavirus, or a combination thereof.

In some examples, the target virus comprises one or more variants of SARS-CoV-2 and the first portion of the target virus comprises the SARS-CoV-2 spike protein. In some examples, the target virus comprises one or more variants of SARS-CoV-2 and the first portion of the target virus comprises the SARS-CoV-2 spike protein receptor binding domain.

In some examples, the capture portion of each of the first plurality of peptides is configured to selectively bind the first portion of the target virus. The capture portion of each of the first plurality of peptides has a binding affinity for the first portion of the target virus. As used herein, “selectively bind” means that the binding affinity of the capture portion of each of the first plurality of peptides for the first portion of the target virus is greater than that of the binding affinity of the capture portion of each of the first plurality of peptides for another agent (e.g., another virus or variant) by a factor of 2 or more (e.g., 3 or more, 4 or more, 5 or more, 6 or more, 7 or more, 8 or more, 9 or more, or 10 or more).

In some examples, the first plurality of peptides can comprise a peptide engineered to be specifically recognized by a protein of the target virus, such as a protein on the surface of the target virus.

The capture portion of each of the first plurality of peptides can, for example, have an average length of 3 amino acids or more (e.g., 4 amino acids or more, 5 amino acids or more, 6 amino acids or more, 7 amino acids or more, 8 amino acids or more, 9 amino acids or more, 10 amino acids or more, 15 amino acids or more, 20 amino acids or more, 25 amino acids or more, 30 amino acids or more, 35 amino acids or more, 40 amino acids or more, 45 amino acids or more, 50 amino acids or more, or 55 amino acids or more). In some examples, the capture portion of each of the first plurality of peptides can have an average length of 60 amino acids or less (e.g., 55 amino acids or less, 50 amino acids or less, 45 amino acids or less, 40 amino acids or less, 35 amino acids or less, 30 amino acids or less, 25 amino acids or less, 20 amino acids or less, 15 amino acids or less, 10 amino acids or less, 9 amino acids or less, S amino acids or less, 7 amino acids or less, 6 amino acids or less, or 5 amino acids or less). The average length of the capture portion of each of the first plurality of peptides can range from any of the minimum values described above to any of the maximum values described above. For example, the capture portion of each of the first plurality of peptides has an average length of from 3 to 60 amino acids (e.g., from 3 to 30 amino acids, from 30 to 60 amino acids, from 3 to 20 amino acids, from 20 to 40 amino acids, from 40 to 60 amino acids, from 3 to 10 amino acids, from 10 to 20 amino acids, from 2.0 to 30 amino acids, from 30 to 40 amino acids, from 40 to 50 amino acids, from 50 to 60 amino acids, from 5 to 60 amino acids, from 3 to 55 amino acids, from 5 to 55 amino acids, from 3 to 50 amino acids, from 3 to 40 amino acids, from 10 to 60 amino acids, or from 20 to 60 amino acids).

In some examples, the binding portion of each of the second plurality of peptides is configured to selectively bind the first portion of the second target virus. The binding portion of each of the second plurality of peptides has a binding affinity for the first portion of the second target virus. As used herein, “selectively bind” means that the binding affinity of the binding portion of each of the second plurality of peptides for the first portion of the second target virus is greater than that of the binding affinity of the binding portion of each of the second plurality of peptides for another agent (e.g., another virus or variant) by a factor of 2 or more (e.g., 3 or more, 4 or more, 5 or more, 6 or more, 7 or more, 8 or more, 9 or more, or 10 or more).

In some examples, the second plurality of peptides can comprise a peptide engineered to be specifically recognized by a protein of the second target virus, such as a protein on the surface of the second target virus.

The binding portion of each of the second plurality of peptides can, for example, have an average length of 3 amino acids or more (e.g., 4 amino acids or more, 5 amino acids or more, 6 amino acids or more, 7 amino acids or more, 8 amino acids or more, 9 amino acids or more, 10 amino acids or more, 15 amino acids or more, 20 amino acids or more, 25 amino acids or more, 30 amino acids or more, 35 amino acids or more, 40 amino acids or more, 45 amino acids or more, 50 amino acids or more, or 55 amino acids or more). In some examples, the binding portion of each of the second plurality of peptides can have an average length of 60 amino acids or less (e.g., 55 amino acids or less, 50 amino acids or less, 45 amino acids or less, 40 amino acids or less, 35 amino acids or less, 30 amino acids or less, 25 amino acids or less, 20 amino acids or less, 15 amino acids or less, 10 amino acids or less, 9 amino acids or less, 8 amino acids or less, 7 amino acids or less, 6 amino acids or less, or 5 amino acids or less). The average length of the binding portion of each of the second plurality of peptides can range from any of the minimum values described above to any of the maximum values described above. For example, the binding portion of each of the second plurality of peptides has an average length of from 3 to 60 amino acids (e.g., from 3 to 30 amino acids, from 30 to 60 amino acids, from 3 to 20 amino acids, from 20 to 40 amino acids, from 40 to 60 amino acids, from 3 to 10 amino acids, from 10 to 20 amino acids, from 20 to 30 amino acids, from 30 to 10 amino acids, from 40 to 50 amino acids, from 50 to 60 amino acids, from 5 to 60 amino acids, from 3 to 55 amino acids, from 5 to 55 amino acids, from 3 to 50 amino acids, from 3 to 40 amino acids, from 10 to 60 amino acids, or from 20 to 60 amino acids).

In some examples, the capture portion of each of the first plurality of peptides and/or the binding portion of each of the second plurality of peptides can independently be a biomimetic peptide.

In some examples, the capture portion of each of the first plurality of peptides comprises an angiotensin-converting enzyme 2 (ACE2) mimetic peptide. In some examples, the target virus comprises one or more variants of SARS-CoV-2 and wherein the capture portion of each of the first plurality of peptides comprises at least 90% identity to IEEQAKTFLDKFNHEAEDLFYQS (SEQ ID NO:1) or LVMGLNVWLRYSK (SEQ ID NO:2).

In some examples, the target virus comprises one or more variants of SARS-CoV-2 and the capture portion of each of the first plurality of peptides is engineered to engage with at least a portion of the spike protein of SARS-CoV-2.

In some examples, the target virus comprises one or more variants of SARS-CoV-2 and wherein the capture portion of each of the first plurality of peptides is configured to selectively bind the first portion of the one or more SARS-CoV-2 variants. In some examples, the target virus comprises one or more variants of SARS-CoV-2 and wherein the capture portion of each of the first plurality of peptides is configured to selectively bind the first portion of the one or more variants of SARS-CoV-2 relative to SARS-CoV-1, MERS-CoV, or a combination thereof. In some examples, the first plurality of peptides comprises at least 90% identity to Cys-PEG₄-IEEQAKTFLDKFNHEAEDLFYQS-NH₂ (Cys-PEG₄-SEQ ID 1) or Cys-PEG₄-LVMIGLNVNWLRYSK (Cys-PEG₄-SEQ ID 2).

### Methods of Making

Also disclosed herein are methods of making any of the assays disclosed herein. For example, the methods can comprise making the peptide-modified nanostructured metal.

In some examples, the methods can comprise contacting the nanostructured metal with a plurality of peptides having a functional group configured to covalently or ionically bond to the nanostructured metal, such as thiol (—SH), carboxyl (—COOH), or amine (—NH) group.

In some examples, the methods can further comprise making the nanostructured metal. The nanostructured metal can be made using standard techniques known in the art.

In some examples, the methods can further comprise making the first plurality of peptides having the functional group, for example using standard techniques known in the art.

In some examples, the nanostructured metal comprises a metal modified with a nanostructure, such as a metal film or layer with one or more nanosized features and the nanostructured metal can be made using printing, lithography, electron beam deposition, thermal deposition, etching, micromachining, laser ablation, and the like, or a combination thereof.

In some examples, the methods can further comprise making a plurality of peptide-modified particles. In some examples, the methods can further comprise disposing the plurality of peptide-modified particles on a substrate, for example using printing, lithographic deposition, electron beam deposition, thermal deposition, spin coating, drop-casting, zone casting, dip coating, blade coating, spraying, vacuum filtration, or combinations thereof.

### Methods of Use

Also disclosed herein are methods of use of any of the assays disclosed herein.

For example, also disclosed herein are methods comprising: contacting any of the assays disclosed herein with a liquid sample; subsequently collecting a surface enhanced Raman signal from the liquid sample and the assay; and processing the surface enhanced Raman signal to determine a property of the liquid sample.

In some examples, the assay comprises a plurality of peptide-modified particles and the plurality of peptide-modified particles are at least partially dispersed in a solvent. In some examples, the methods can comprise contacting the liquid sample with the plurality of peptide-modified particles in the solvent, to form a mixture. In some examples, the mixture can then be deposited on a substrate, e.g. before collecting the surface enhanced Raman signal.

In some examples, the assay comprises a plurality of peptide-modified particles and the plurality of peptide-modified particles are at least partially dispersed in a solvent. In some examples, the methods can comprise depositing the plurality of peptide-modified particles onto a substrate and subsequently contacting the deposited plurality of peptide-modified particles with the liquid sample.

The liquid sample can comprise any liquid sample of interest. By way of example the liquid sample can comprise a bodily fluid. “Bodily fluid”, as used herein, refers to a fluid composition obtained from or located within a human or animal subject. Bodily fluids include, but are not limited to, urine, whole blood, blood plasma, serum, tears, semen, saliva, sputum, exhaled breath, nasal secretions, pharyngeal exudates, bronchoalveolar lavage, tracheal aspirations, interstitial fluid, lymph fluid, meningeal fluid, amniotic fluid, glandular fluid, feces, perspiration, mucous, vaginal or urethral secretion, cerebrospinal fluid, and transdermal exudate. Bodily fluid also includes experimentally separated fractions of all of the preceding solutions, as well as mixtures containing homogenized solid material, such as feces, tissues, and biopsy samples. In some examples, the liquid sample comprises a bodily fluid and the bodily fluid comprises saliva, sputum, nasal secretions, pharyngeal exudates, bronchoalveolar lavage, tracheal aspirations, mucous, or a combination thereof.

In some examples, the methods can further comprise collecting the liquid sample. The liquid sample can, for example, be collected using a nasal or oropharyngeal swab. In some examples, the liquid sample is collected in a vial.

In some examples, the methods can further comprise purifying or treating the liquid sample before contacting the liquid sample with the assay. Purifying the liquid sample can, for example, comprise filtering, centrifuging, electrophoresis, extraction, or a combination thereof. Treating the liquid sample can, for example, comprise neutralization, buffer exchange, or a combination thereof.

In some examples, the liquid sample further comprises serum albumin (e.g., bovine serum albumin (BSA), human serum albumin, etc.). In some examples, the methods can further comprise adding serum albumin to the liquid sample before or concurrently with contacting the liquid sample with the assay.

The liquid sample can, for example, have a volume of 1 microliter (μL) or more (e.g., 2 μL or more, 3 μL or more, 4 μL or more, 5 μL or more, 10 μL or more, 15 μL or more, 20 μL or more, 25 μL or more, 30 μL or more, 35 μL or more, 40 μL or more, 45 μL or more, 50 μL or more, 60 μL or more, 70 μL or more, 80 μL or more, 90 μL or more, 100 μL or more, 125 μL or more, 150 μL or more, 175 μL or more, 200 μL or more, 225 μL or more, 250 μL or more, 300 μL or more, 350 μL or more, 400 μL or more, 450 μL or more, 500 μL or more, 600 μL or more, 700 μL or more, 800 μL or more, 900 μL. or more, 1 milliliter (mL) or more, 2 mL or more, 3 mL or more, 4 mL or more, 5 mL or more, 10 mL or more, 15 mL or more, 20 mL or more, 25 mL or more, 30 mL or more, 35 mL or more, 40 mL or more, or 45 mL or more). In some examples, the liquid sample can have a volume of 50 milliliters (mL) or less (e.g., 45 mL or less, 40 mL or less, 35 mL or less, 30 mL, or less, 25 mL, or less, 20 mL or less, 15 mL or less, 10 mL or less, 5 mL or less, 4 mL or less, 3 mL or less, 2 mL or less, 1 mL or less, 900 μL or less, 800 μL or less, 700 μL or less, 600 μL or less, 500 μL or less, 450 μL or less, 400 μL or less, 350 μL or less, 300 μL or less, 250 μL or less, 225 μL or less, 200 μL or less, 175 μL or less, 150 μL or less, 125 μL or less, 100 μL or less, 90 μL or less, 80 μL or less, 70 μL or less, 60 μL or less, 50 μL or less, 45 μL or less, 40 μL or less, 35 μL or less, 30 μL, or less, 25 μL, or less, 20 μL or less, 15 μL or less, 10 μL or less, or 5 μL or less). The volume of the liquid sample can range from any of the minimum values described above to any of the maximum values described above. For example, the liquid sample can have a volume of from 1 microliter (μL) to 50 milliliters (mL) (e.g., from 1 μL to 500 μL, from 500 μL to 50 mL, from 1 μL to 10 μL, from 10 μL to 1 mL, from 1 mL to 50 mL, from 1 μL to 45 mL, from 5 μL to 50 mL, from 5 μL to 45 mL, from 1 μL to 100 μL, or from 1 mL to 10 mL).

The property of the liquid sample can, for example, comprise the presence of the target virus the liquid sample, the concentration of the target virus in the liquid sample, the identity of the target virus, the identity of the variant of the target virus, or a combination thereof.

In some examples, the property of the liquid sample comprises the presence of the target virus the liquid sample, the presence of the second target virus in the sample, the concentration of the target virus in the liquid sample, the concentration of the second target virus in the liquid sample, the identity of the target virus, the identity of the second target virus, the identity of the variant of the target virus, the identity of the variant of the second target virus, or a combination thereof.

In some examples, the target virus comprises one or more variants of SARS-CoV-2 and the property of the liquid sample comprises the presence of one or more SARS-CoV-2 variants in the liquid sample, the concentration of one or more SARS-CoV-2 variants in the liquid sample, the identity of one or more variants of SARS-CoV-2 in the liquid sample, or a combination thereof.

In some examples, the methods and/or the assay have a limit of detection of 500 nM or less (e.g., 400 nM or less, 300 nM or less, 200 nM or less, 100 nM or less, 50 nM or less, 10 nM or less, or 1 nM or less).

In some examples, the methods can further comprise diagnosing and/or monitoring an infection with the target virus in a subject based on the property of the liquid sample. In some examples, the methods can further comprise selecting a course of therapy for the subject based on the property of the liquid sample.

In some examples, processing the surface enhanced Raman signal to determine the property of the liquid sample comprises machine learning. In some examples, processing the surface enhanced Raman signal to determine the property of the liquid sample comprises multivariate analysis of peak characteristics, e.g. using multivariate curve resolution (MCR). In some examples, processing the surface enhanced Raman signal to determine the property of the liquid sample comprises comparing to a standard curve.

### Devices

Also disclosed herein are devices, for example for performing any of the methods described herein.

Referring now to FIG. 1, also disclosed herein are devices 100 comprising: a receptacle 102 configured to at least partially contain an assay 104 (e.g., any one of the assays disclosed herein); an excitation source 106; a detector 108; and a computing device 110. The receptacle 102 is further configured to position the assay 104 such that the assay 104 is in optical communication with the excitation source 106 and the detector 108. The computing device 110 is configured to receive and process an electromagnetic signal from the detector 108. When the device 100 is assembled together with a liquid sample 112, then: the receptacle 102 is configured to at least partially contain the assay 104 and the liquid sample 112, wherein the liquid sample 112 is in contact with the assay 104, and position the assay 104 and the liquid sample 112 such that the assay 104 and the liquid sample 112 are in optical communication with the excitation source 106 and the detector 108; the excitation source 106 is configured to apply an excitation signal 114 to the liquid sample 112 and the assay 114; the detector 108 is configured to collect a surface enhanced Raman signal 116 from the liquid sample 112 and/or the assay 104; and the computing device 110 is configured to process the surface enhanced Raman signal to determine a property of the liquid sample. The excitation source 106 and/or the detector 108 can, for example, comprise a Raman spectrometer.

In some examples, the device 100 is further configured to output the property of the liquid sample and/or a feedback signal based on the property of the liquid sample. In some examples, the device 100 can further comprise one or more output devices (e.g., a display, speakers, printer, LED, etc.) configured to output the property of the liquid sample and/or a feedback signal based on the property of the liquid sample. The feedback signal can, for example, comprise haptic feedback, auditory feedback, visual feedback, or a combination thereof.

In some examples, the device 100 is a point-of-care device. In some examples, the device 100 is a handheld device. In some examples, the device 100 is a benchtop device. In some examples, the device 100 is a high-throughput device.

For example, the device 100 can be a high-throughput device configured to analyze a plurality of liquid samples. In certain examples, the receptacle 102 can be a well plate, such as a 96 well plate.

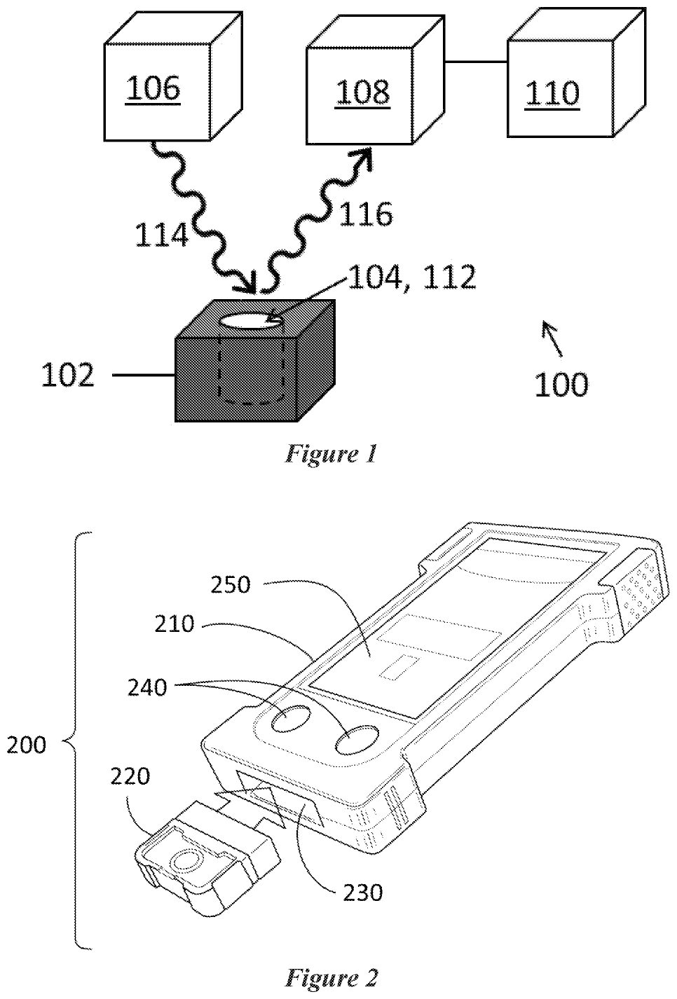

Referring now to FIG. 2, in some examples the device is a handheld device 200, wherein the device is disposed within a housing 210 configured to be held in the hand of a user. The handheld device 200 comprises a receptacle 220 configured to at least partially contain an assay (e.g., any one of the assays disclosed herein). The handheld device 200 can further include a receiving unit 230 configured to receive the receptacle 220. The handheld device further includes an excitation source; a detector; and a computing device disposed within the housing 210.

When the handheld device 200 is assembled together with a liquid sample, then the receptacle 220 is configured to at least partially contain the assay and the liquid sample, such that the liquid sample is in contact with the assay. When the receptacle 220 is inserted in the receiving unit 230, the receptacle 220 is configured to position the assay and the liquid sample such that the assay and the liquid sample are in optical communication with the excitation source and the detector; the excitation source is configured to apply an excitation signal to the liquid sample and the assay; the detector is configured to collect a surface enhanced Raman signal from the liquid sample and/or the assay; and the computing device is configured to process the surface enhanced Raman signal to determine a property of the liquid sample. The excitation source and/or the detector can, for example, comprise a Raman spectrometer.

In some examples, the handheld device 200 can further comprise one or more input devices configured to provide user inputs to the excitation source, the detector, the computing device, or a combination thereof. For example, the input device can comprise one or more input keys or buttons 240 and/or an electronic screen, such as a touchscreen 250.

In some examples, the handheld device 200 is further configured to output the property of the liquid sample and/or a feedback signal based on the property of the liquid sample. In some examples, the handheld device 200 can further comprise one or more output devices (e.g., a display, speakers, printer, LED, etc.) configured to output the property of the liquid sample and/or a feedback signal based on the property of the liquid sample. The feedback signal can, for example, comprise haptic feedback, auditory feedback, visual feedback, or a combination thereof.

In any of the devices disclosed herein (100, 200), the amount of time from contacting the liquid sample with the assay to output of the property of the liquid sample and/or a feedback signal based on the property of the liquid sample can be 1 hour or less (e.g., 55 minutes or less, 50 minutes or less, 45 minutes or less, 40 minutes or less, 35 minutes or less, 30 minutes or less, 25 minutes or less, 20 minutes or less, 15 minutes or less, 10 minutes or less, 9 minutes or less, 8 minutes or less, 7 minutes or less, 6 minutes or less, 5 minutes or less, 4 minutes or less, 3 minutes or less, 2 minutes or less, 1 minute or less, 55 seconds or less, 50 seconds or less, 45 seconds or less, 40 seconds or less, 35 seconds or less, 30 seconds or less, 25 seconds or less, 20 seconds or less, 15 seconds or less, 10 seconds or less, 9 seconds or less, 8 seconds or less, 7 seconds or less, 6 seconds or less, or 5 seconds or less). In some examples, the amount of time from contacting the liquid sample with the assay to output of the property of the liquid sample and/or a feedback signal based on the property of the liquid sample can be 1 second or more (e.g., 2 seconds or more, 3 seconds or more, 4 seconds or more, 5 seconds or more, 10 seconds or more, 15 seconds or more, 20 seconds or more, 25 seconds or more, 30 seconds or more, 35 seconds or more, 40 seconds or more, 45 seconds or more, 50 seconds or more, 55 seconds or more, 1 minute or more, 2 minutes or more, 3 minutes or more, 4 minutes or more, 5 minutes or more, 10 minutes or more, 15 minutes or more, 20 minutes or more, 25 minutes or more, 30 minutes or more, 35 minutes or more, 40 minutes or more, 45 minutes or more, 50 minutes or more, or 55 minutes or more). The amount of time from contacting the liquid sample with the assay to output of the property of the liquid sample and/or a feedback signal based on the property of the liquid sample can range from any of the minimum values described above to any of the maximum values described above. For example, the amount of time from contacting the liquid sample with the assay to output of the property of the liquid sample and/or a feedback signal based on the property of the liquid sample can be from 1 second to 1 hour (e.g., from 1 second to 1 minute, from 1 minute to 1 hour, from 1 second to 15 minutes, from 15 minutes to 30 minutes, from 30 minutes to 45 minutes, from 45 minutes to 1 hour, from 5 seconds to 1 hour, from 1 second to 55 minutes, from 5 seconds to 55 minutes, from 1 second to 45 minutes, from 1 second to 30 minutes, from 1 second to 10 minutes, from 1 second to 5 minutes, from 1 second to 30 seconds, or from 1 second to 10 seconds).

The liquid sample can comprise any liquid sample of interest. By way of example the liquid sample can comprise a bodily fluid. “Bodily fluid”, as used herein, refers to a fluid composition obtained from or located within a human or animal subject. Bodily fluids include, but are not limited to, urine, whole blood, blood plasma, serum, tears, semen, saliva, sputum, exhaled breath, nasal secretions, pharyngeal exudates, bronchoalveolar lavage, tracheal aspirations, interstitial fluid, lymph fluid, meningeal fluid, amniotic fluid, glandular fluid, feces, perspiration, mucous, vaginal or urethral secretion, cerebrospinal fluid, and transdermal exudate. Bodily fluid also includes experimentally separated fractions of all of the preceding solutions, as well as mixtures containing homogenized solid material, such as feces, tissues, and biopsy samples. In some examples, the liquid sample comprises a bodily fluid and the bodily fluid comprises saliva, sputum, nasal secretions, pharyngeal exudates, bronchoalveolar lavage, tracheal aspirations, mucous, or a combination thereof.

In some examples, the liquid sample further comprises serum albumin (e.g., bovine serum albumin (BSA), human serum albumin, etc.).

The liquid sample can, for example, have a volume of 1 microliter (μL) or more (e.g., 2 μL or more, 3 μL or more, 4 μL, or more, 5 μL or more, 10 μL or more, 15 μL. or more, 20 μL or more, 25 μL or more, 30 μL or more, 35 μL or more, 40 μL or more, 45 μL or more, 50 μL or more, 60 μL or more, 70 μL or more, 80 μL or more, 90 μL or more, 100 μL or more, 125 μL or more, 150 μL or more, 175 μL or more, 200 μL or more, 225 μL or more, 250 μL or more, 300 μL or more, 350 μL or more, 400 μL or more, 450 μL or more, 500 μL or more, 600 μL or more, 700 μL or more, 800 μL or more, 900 μL or more, 1 milliliter (mL) or more, 2 mL or more, 3 mL or more, 4 mL or more, 5 mL or more, 10 mL or more, 15 mL or more, 20 mL or more, 25 mL or more, 30 ml- or more, 35 mL or more, 40 mL or more, or 45 ml- or more), In some examples, the liquid sample can have a volume of 50 milliliters (mL) or less (e.g., 45 mL or less, 40 mL or less, 35 mL or less, 30 mL or less, 25 mL or less, 20 ml, or less, 15 mL or less, 10 mL or less, 5 mL or less, 4 mL or less, 3 mL or less, 2 mL or less, 1 mL or less, 900 μL or less, 800 μL or less, 700 μL or less, 600 μL or less, 500 μL, or less, 450 μL or less, 400 μL or less, 350 μL or less, 300 μL or less, 250 μL or less, 225 μL or less, 200 μL or less, 175 μL or less, 150 μL or less, 125 μL or less, 100 μL or less, 90 μL or less, 80 μL or less, 70 μL or less, 60 μL or less, 50 μL or less, 45 μL or less, 40 μL or less, 35 μL or less, 30 μL or less, 25 μL or less, 20 μL or less, 15 μL or less, 10 μL or less, or 5 μL or less). The volume of the liquid sample can range from any of the minimum values described above to any of the maximum values described above. For example, the liquid sample can have a volume of from 1 microliter (μL) to 50 milliliters (mL) (e.g., from 1 μL to 500 μL, from 500 μL to 50 mL, from 1 μL to 10 μL, from 10 μL to 1 mL, from 1 mL to 50 mL, from 1 μL to 45 mL, from 5 μL to 50 mL, from 5 μL to 45 mL, from 1 μL to 100 μL, or from 1 mL to 10 mL).

The property of the liquid sample can, for example, comprise the presence of the target virus the liquid sample, the concentration of the target virus in the liquid sample, the identity of the target virus, the identity of the variant of the target virus, or a combination thereof.

In some examples, the property of the liquid sample comprises the presence of the target virus the liquid sample, the presence of the second target virus in the sample, the concentration of the target virus in the liquid sample, the concentration of the second target virus in the liquid sample, the identity of the target virus, the identity of the second target virus, the identity of the variant of the target virus, the identity of the variant of the second target virus, or a combination thereof.

In some examples, the target virus comprises one or more variants of SARS-CoV-2 and the property of the liquid sample comprises the presence of one or more SARS-CoV-2 variants in the liquid sample, the concentration of one or more SARS-CoV-2 variants in the liquid sample, the identity of one or more variants of SARS-CoV-2 in the liquid sample, or a combination thereof.

In some examples, processing the surface enhanced Raman signal to determine the property of the liquid sample comprises machine learning. In some examples, processing the surface enhanced Raman signal to determine the property of the liquid sample comprises multivariate analysis of peak characteristics, e.g. using multivariate curve resolution (MCR). In some examples, processing the surface enhanced Raman signal to determine the property of the liquid sample comprises comparing to a standard curve.

In some examples, the device can have a limit of detection of 500 nM or less (e.g., 400 nM or less, 300 nM or less, 200 nM or less, 100 nM or less, 50 nM or less, 10 nM or less, or 1 nM or less).

The devices (100, 200) comprise a computing device. Any of the methods disclosed herein can be carried out in whole or in part on one or more computing or processing devices.

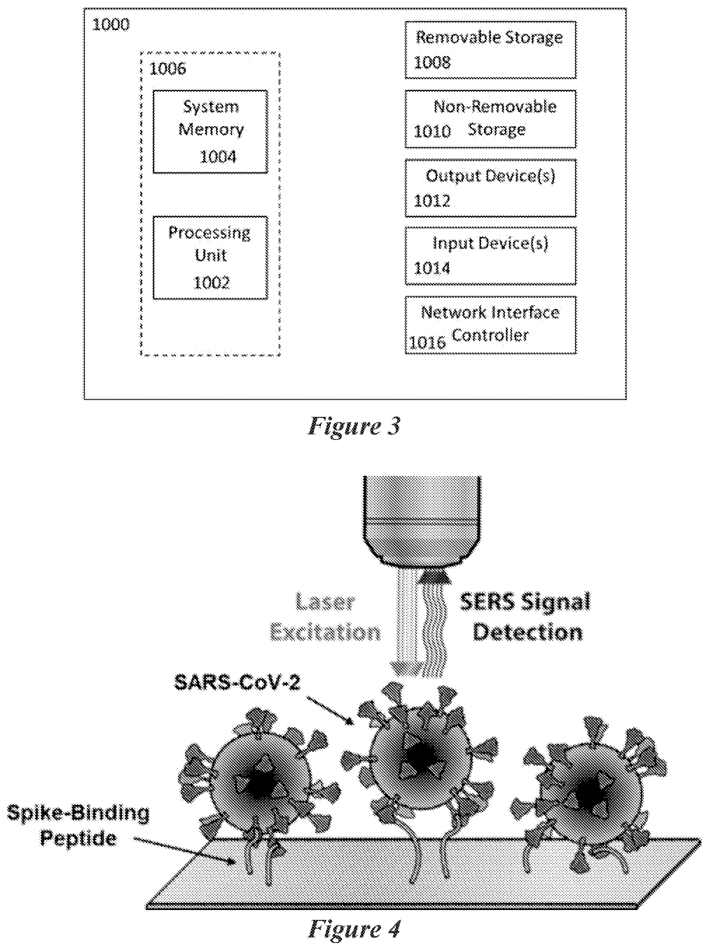

FIG. 3 illustrates an example computing device 1000 upon which examples disclosed herein may be implemented. The computing device 1000 can include a bus or other communication mechanism for communicating information among various components of the computing device 1000. In its most basic configuration, computing device 1000 typically includes at least one processing unit 1002 (a processor) and system memory 1004. Depending on the exact configuration and type of computing device, system memory 1004 may be volatile (such as random access memory (RAM)), non-volatile (such as read-only memory (ROM), flash memory, etc.), or some combination of the two. This most basic configuration is illustrated in FIG. 3 by a dashed line 1006. The processing unit 1002 may be a standard programmable processor that performs arithmetic and logic operations necessary for operation of the computing device 1000.

The computing device 1000 can have additional features/functionality. For example, computing device 1000 may include additional storage such as removable storage 1008 and non-removable storage 1010 including, but not limited to, magnetic or optical disks or tapes. The computing device 1000 can also contain network connection(s) 1016 that allow the device to communicate with other devices. The computing device 1000 can also have input device(s) 1014 such as a keyboard, mouse, touch screen, antenna or other systems configured to communicate with the camera in the system described above, etc. Output device(s) 1012 such as a display, speakers, printer, etc. may also be included. The additional devices can be connected to the bus in order to facilitate communication of data among the components of the computing device 1000.

The processing unit 1002 can be configured to execute program code encoded in tangible, computer-readable media. Computer-readable media refers to any media that is capable of providing data that causes the computing device 1000 (i.e., a machine) to operate in a particular fashion. Various computer-readable media can be utilized to provide instructions to the processing unit 1002 for execution. Common forms of computer-readable media include, for example, magnetic media, optical media, physical media, memory chips or cartridges, a carrier wave, or any other medium from which a computer can read. Example computer-readable media can include, but is not limited to, volatile media, non-volatile media, and transmission media. Volatile and non-volatile media can be implemented in any method or technology for storage of information such as computer readable instructions, data structures, program modules or other data and common forms are discussed in detail below. Transmission media can include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1002 can execute program code stored in the system memory 1004. For example, the bus can carry data to the system memory 1004, from which the processing unit 1002 receives and executes instructions. The data received by the system memory 1004 can optionally be stored on the removable storage 1008 or the non-removable storage 1010 before or after execution by the processing unit 1002.

The computing device 1000 typically includes a variety of computer-readable media. Computer-readable media can be any available media that can be accessed by device 1000 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 1004, removable storage 1008, and non-removable storage 1010 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1000. Any such computer storage media can be part of computing device 1000.

It should be understood that the various techniques described herein can be implemented in connection with hardware or software or, where appropriate, with a combination thereof. Thus, the methods, systems, and associated signal processing of the presently disclosed subject matter, or certain aspects or portions thereof, can take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs can implement or utilize the processes described in connection with the presently disclosed subject matter, e.g, through the use of an application programming interface (API), reusable controls, or the like. Such programs can be implemented in a high level procedural or object-oriented programming language to communicate with a computer system. However, the program(s) can be implemented in assembly or machine language, if desired. In any case, the language can be a compiled or interpreted language and it may be combined with hardware implementations.

In certain examples, the methods can be carried out in whole or in part on a computing device 1000 comprising a processor 1002 and a memory 1004 operably coupled to the processor 1002, the memory 1004 having further computer-executable instructions stored thereon that, when executed by the processor 1002, cause the processor 1002 to carry out one or more of the method steps described above.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Catching COVID: Engineering Peptide-Modified Surface-Enhanced Raman Spectroscopy Sensors for SARS-CoV-2

ABSTRACT: COVID-19 remains an ongoing issue across the globe, highlighting the need for a rapid, selective, and accurate sensor for SARS-CoV-2 and its emerging variants. The chemical specificity and signal amplification of surface-enhanced Raman spectroscopy (SERS) could be advantageous for developing a quantitative assay for SARS-CoV-2 with improved speed and accuracy over current testing methods. Here, the challenges associated with SERS detection of viruses have been tackled. As viruses are large, multicomponent species, they can yield different SERS signals, but also other abundant biomolecules present in the sample can generate undesired signals. To improve selectivity in complex biological environments, peptides were employed as capture probes for viral proteins and an angiotensin-converting enzyme 2 (ACE2) mimetic peptide-based SERS sensor for SARS-CoV-2 was developed. The unique vibrational signature of the spike protein bound to the peptide-modified surface is identified and used to construct a multivariate calibration model for quantification. The sensor demonstrates a 300 nM limit of detection and high selectivity in the presence of excess bovine serum albumin. This work provides the basis for designing a SERS-based assay for the detection of SARS-CoV-2 as well as engineering SERS biosensors for other viruses in the future.

INTRODUCTION. The swift and accurate diagnosis of COVID-19 remains a critical factor in preventing the spread of the disease, which to date has surpassed 176 million cases worldwide (World Health Organization Coronavirus Disease (COVID-19) Dashboard; World Health Organization: 2021 https://covid19.who.int). Current detection methods include polymerase chain reaction (PCR), which requires long run times and significant sample preparation, and antibody testing, which suffers from high false negative rates and detects an immune response from the virus rather than the virus itself (Winter, L. False Negatives in Quick COVID-19 Test Near 15 Percent: Study; LabX Media Group: 2020). In addition, diagnostic assays that are rapidly adaptable to virus mutations and variants are needed, as the rapid proliferation of the virus can alter the nucleic acid sequence or surface marker of the virus, rendering it undetectable by current methods. There remains a need for a quick, selective, and error-free sensor for SARS-CoV-2.

Surface enhanced Raman spectroscopy (SERS) is a rapid, sensitive vibrational spectroscopy technique that requires minimal sample preparation and gives a highly specific molecular fingerprint (Smith E.; Dent, G. Modern Raman Spectroscopy-A Practical Approach; John Wiley & Sons, Ltd.: England, 2005). Recognized in 1977, SERS takes advantage of the properties of noble metal nanostructures, which produce a localized electric field upon laser excitation, giving enhanced Raman signals from analytes on the surface (Jeanmaire D L et al. J. Electroanal. Chem. Interfacial Electrochem. 1977, 84, 1-20). SERS provides a sensitive response, which allows for quantification, and can yield low limits of detection, even down to the single molecule level (Langer J et al. ACS Nano 2020, 14, 28-117). The spectrum contains information about the identities of the adsorbed species and their orientations on the nanostructure surface, providing chemically specific signals to identify analytes. SERS has emerged as a popular analytical method for sensing biomolecules, including proteins and viruses (Nguyen A H et al. Rev. Anal. Chem. 2017, 36, 20160037). This technique could be used to develop a quantitative assay for SARS-CoV-2 that would provide immediate and accurate COVID test results for patients around the world.

Engineering an effective SERS sensor requires tailoring surface chemistry to enhance the SERS response and ensure a reproducible, quantitative diagnostic. While SERS can detect trace amounts of target molecules, other components present in biological assays can generate interference and complicate detection (Tate J et al. Clin. Biochem. Rev. 2004, 25, 105-120). Proper modification of the nanostructured surface with a capture agent can increase affinity for a specific analyte in complex environments (Wang F et al. Sensors 2017, 17, 2689; Driskell J D et al. Anal. Chem. 2007, 79, 41141-41148). Antibodies are a common recognition element for sensing virus particles with SERS (Karn-orachai K et al. RSC Adv. 2016, 6, 97791-97799), but they are large and bulky, producing complex SERS spectra with a great deal of signal resulting from the antibody itself and also suffering from the same complications as existing immunosensing strategies (Tate J et al. Clin. Biochem. Rev. 2004, 25, 105-120). Instead, smaller motifs such as DNA aptamers or peptides can be utilized as capture probes to target viruses (Chen H et al. ACS Sens. 2021, 6(6), 2378; Negri P et al. Anal. Chem. 2012, 84, 5501-5508; Fu X et al. Biosens. Bioelectron. 2016, 78, 530-537). These small capture agents are advantageous due to their facile synthesis and better stability compared to antibodies. Given the near-field enhancement of SERS signals, small capture molecules attached to the nanostructures can concentrate the analyte at the surface where the electric field enhancement is the greatest and thus improve limits of detection. Additionally, the SERS signal depends on the orientation of the analyte on the substrate. Capture molecules can uniformly orient the analyte on the surface, improving signal reproducibility, increasing selectivity, and enabling quantitative models (Ma H et al. Anal. Chem. 2019, 91, 8767-8771). Recently, this approach has successfully detected the influenza virus and HIV-1 DNA by SERS (Negri P et al. Anal. Chem. 2012, 84, 5501-5508; Fu X et al. Biosens. Bioelectron. 2016, 78, 530-537).

Generating a reproducible response from a specific analyte enables machine learning algorithms to analyze the observed signal (Lussier F et al. Trends Anal. Chem. 2020, 121, 115796; Lussier F et al. ACS Nano 2019, 13(22), 1403-1411; Thrift W et al. SPIE, Biosensing and Sanomedicine X 2017, Proceedings Volume 10352, 1035205; Thrift W J et al. Anal. Chem. 2019, 91, 13337-13342). As opposed to performing univariate analysis on a peak characteristic of the analyte, limits of detection and selectivity can be improved by utilizing multivariate analysis techniques, such as multivariate curve resolution (MCR), to create a calibration model based on the entire spectral signature (Goodacre R et al. Trends Anal. Chem. 2018, 102, 359-368). Using a simple capture agent reproducibly orients the desired analyte on the surface (Ma H et al. Anal. Chem. 2019, 91, 8767-8771), giving rise to a conserved SERS signal that can be extracted from complex mixtures. With appropriate preprocessing, such as normalizing the SERS intensity to an internal standard, quantitative calibration models can be obtained (Perez-Jiménez A I et al. Chem. Sci. 2020, 1, 4563-4577; Nguyen A et al. Analyst 2016, 111, 3630-3635; Bell S E J et al. Analyst 2005, 130, 545-549). Building models based on a target spectrum can significantly enhance selectivity in the presence of similar, potentially interfering molecules (Villa J E L et al. Analyst 2016, 141, 1966-1972; Mamián-López M B et al Anal. Chim. Acta 2013, 760, 53-59).

Here, a peptide-based SERS sensor for SARS-CoV-2 is presented (FIG. 4), which may provide faster, more accurate detection and aid in stopping the spread of COVID-19. SARS-CoV-2 binds to the ACE2 receptor through its spike surface proteins (Wrapp D et al. Science 2020, 367, 1260-1263). The receptor binding domain of the spike protein and its interaction with ACE2 have been thoroughly characterized through cryo-electron microscopy and molecular dynamics simulations (Yuan M et al. Science 2020, 368, 630-633; Nguyen H L et al J. Phys. Chem. B 2020, 124, 7336-7347). A peptide sequence derived from the domain of ACE2 that binds the receptor binding domain (RBD) was synthesized to selectively capture the SARS-CoV-2 spike protein on a SERS active substrate (Zhang G et al. BioRxiv 2020, DOI: 10.1101/2020.030.19.999318). It is demonstrated that SERS can be used to detect the binding of the spike protein to this peptide. The resulting SERS signal from the peptide-modified substrate was used to identify the vibrational signature of the spike protein. This sensor enhances the selectivity and enables detection of the spike protein in heterogeneous samples. In addition, the spike protein was able to be quantified through the use of multivariate analysis, yielding limits of detection in the nanomolar range. This sensor offers a new approach that may be effective for rapid detection of SARS-CoV-2 and other future pathogens.

### EXPERIMENTAL METHODS

Chemicals and Materials. All purchased chemicals were used without further purification. Rink amide MBHA resin was purchased from Chem-Impex. Fmoc-(PEG)₄-OH was purchased from PurePEG. Alginate, Fmoc-protected amino acids, biotin, HBTU, PyBOP, Oxyma pure, DIC, TFA, TIPS, BSA, NaBH₄, and 2-mercaptoethanol were purchased from Sigma-Aldrich. TCEP HCl, DMSO, and 1×PBS were purchased from Thermo Fisher. Baculovirs insect-derived SARS-CoV-2 Spike RBD-His (Cat #: 40592-V08B), SARS-CoV-2 Spike S1+S2-His (Cat #: 40589-V08B1), SARS-CoV Spike RBD-His (Cat #: 40150-V08B2), and MERS-CoV Spike RBD-His (Cat #: 40071-V08B1) were purchased from SinoBiological.

Peptide Synthesis and Purification. All peptides were synthesized using an automated standard fluoren-9-ylmethoxycarbon-yl (Fmoc) solid-phase peptide synthesis method (Liberty Blue, CEM) on rink amide MBHA resin (100-200 mesh, 0.77 mmol/g). Peptides were cleaved from the resin using a solution of 95% trifluoroacetic acid (TFA), 2.5% triisopropylsilane (TIPS), and 2.5% dH₂O. The acid was evaporated, and the crude peptide was purified using reverse-phase HPLC (Shimadzu UFLC, Ultra C18 5 μM, 100×10 mm column) with a gradient of 0.1% TFA in water (solvent A) and acetonitrile (solvent B) over 50 min. Purified peptides were lyophilized and stored at −20° C. Purity was confirmed by electrospray ionization mass spectrometry and HPLC.

The Peptide names and corresponding sequences are shown in Table 1.

TABLE 1
Names and sequences of all reported peptides.

| Peptide Name | Peptide Sequence |
|---|---|
| Cys-SBP | C-IEEQAKTFLDKFNHEAEDLFYQS-NH₂ (Cys-SEQ ID 1) |
| Cys-SBP-PEG₄ | C-PEG₄-IEEQAKTFLDKFNHEAEDLFYQS-NH₂ (Cys-PEG₄-SEQ ID 1) |
| Biotin-SBP | Biotin-IEEQAKTFLDKFNHEAEDLFYQS-NH₂ (Biotin-SEQ ID 1) |
| Biotin-SBP-PEG₄ | Biotin-PEG₄-IEEQAKTFLDKFNHEAEDLFYQS-NH₂ |
| | (Biotin-PEG₄-SEQ ID 1) |

X-ray Photoelectron Spectroscopy (XPS). Gold-coated Silmeco SERS substrates were pre-cleaned by heating to 175° C. for 10 min under a stream of nitrogen gas. A 1 mM solution of cysteine-modified peptide (20% DMSO, 2 mM TCEP, in water) was reduced for 1 h. The substrates were submerged in the reduced peptide solution overnight to functionalize the gold surface. Substrates were then washed with 1 mL of sterile water and backfilled by exposure to 100 μM 2-mercaptoethanol for 1 h. Substrates were rinsed in sterile water and dried before use. To assess protein binding, modified substrates were incubated for 1 h with 1 μM RBD in PBS followed by three washes in water.

XPS spectra were recorded using a Kratos Axis Ultra DLD X-ray photoelectron spectrometer with monochromatic Al Kα source at 150 W. The spot size are was 300 μm×700 μM. Survey scans over a binding energy range of 0-1200 eV were taken for each sample with a constant detector pass energy range of 80 eV followed by a high-resolution XPS measurement (20 eV pass energy) for quantitative determination of binding energy and atomic concentration. Background subtraction, peak integration, and fitting were carried out using Kratos software. To convert peak areas to surface concentration, default instrument sensitivity factors were used (N=0.477, C=0.278, O=0.780, S=0.668, Si=0.328, and Au=6.250).

Confocal Laser Scanning Microscopy (CLSM). Surfaces were modified with peptide and RBD as described above and were then fixed with 2% paraformaldehyde and 2.5% glutaraldehyde in PBS for 20 min. The fixed substrates were blocked with 2% BSA for 30 min, washed with PBS, and incubated with primary CR3022 antibody (recombinant anti-SARS-CoV-2 spike chimeric rabbit monoclonal antibody, 10 μg/mL) at room temperature for 1 h. The substrates were washed with PBS and incubated for another hour with goat anti-rabbit IgG-Alexa488 (4 μg/mL). The immunolabeled substrates were washed with sterile water before being mounted on a glass coverslip for imaging. Images were taken on a Zeiss 710 laser scanning confocal microscope.

Scanning Electron Microscopy (SEM). For SEM, substrates were cleaned or modified with peptide as described above and were then dried under a stream of nitrogen gas. For immunolabeled SEM surfaces, substrates modified with SBP-PEG₄ were incubated for 1 h with 1 μM RBD in PBS and washed three times. The surface was blocked with 2% BSA for 30 min followed by incubation with primary CR3022 anti-RBD antibody (recombinant anti-SARS-CoV-2 spike chimeric rabbit monoclonal antibody, 10 μg/mL) for 1 h at room temperature. Unbound primary antibody was washed away, and the surface was incubated with goat anti-rabbit IgG conjugated to 20 nm AuNPs for 1 h. The AuNP-labeled substrate was washed three times with sterile water before imaging. Substrates were mounted on SEM stubs using double-sided copper tape. Images were collected using an FEI Helios 600 Nanolab Dual Beam System operating at a 5.00 kV accelerating voltage.

Biolayer Interferometry (BLI). Dissociation constants (K_{d}) of peptides were measured by biolayer interferometry (BLI; ForteBio Octet Red 384). Streptavidin biolayer interferometry tips were functionalized with 2.5 μM biotin-SBP and biotin-SBP-PEG₄ in 1× kinetic buffer (1×PBS with 0.1% BSA and 0.05% Tween 20). Peptide-modified tips were incubated with various concentrations of SARS-CoV-2 receptor binding domain from 0 to 5 μM for 400 s. Then, dissociation was measured for 600 s. Corresponding binding affinities of peptides were analyzed with steady-state analysis using the HT analysis software. The K_{d} for SBP and SBP-PEG₄ were 4.4±0.5 and 2.9±1.4 μM, respectively. Specificity measurements were carried out using the method described above with the SPB-PEG₄ peptide. Each receptor binding domain (SARS-CoV-2, SARS-CoV-1, and MERS) was tested at 2 μM.

Circular Dichroism (CD). Circular dichroism spectra were obtained on a Chirascan Plus Spectropolarimeter using a 1 mm path length cuvette. Cysteine-modified peptides were solubilized in PBS at 100 μM. Spectra were recorded from 200 to 300 nm.

Surface-Enhanced Raman Spectroscopy (SERS). SERS spectra were obtained using a Renishaw inVia Qontor confocal Raman microscope equipped with a CCD camera. A continuous wave laser at 785 nm, a 1200 grooves/mm grating, a 50× objective with NA=0.50, and 1 s acquisition times were used for all measurements.

SERS substrates are advantageous for quantification because they can be designed to have homogeneous properties, yielding more reproducible signal enhancement than nanoparticles (Asiala S M et al. Analyst 2011, 136, 4472). For SERS measurements, commercial gold Silmeco substrates were first cleaned by gently heating to 175° C. on a hot plate for 10 min. The cleanliness of the substrates was then assessed before use by screening their initial SERS signal for unexpected peaks from contaminants. If necessary, they were cleaned through immersion in a series of solvents, including 1 mM NaBH₄ for 3 min and DMSO or ethanol for 10 min. After cleaning, substrates were either used without modification or functionalized with the cysteine-modified peptides described above. For peptide-functionalization, a 1 mM solution of peptide was prepared (20% DMSO and 2 mM TCEP in ultrapure water) and allowed to reduce for 30 min. Peptide solution was added to substrates and left overnight for functionalization. Substrates were rinsed with water, backfilled with 100 μM 2-mercaptoethanol for 30 min, and rinsed with water again before use.

SARS-CoV-2 spike protein, SARS-CoV-2 receptor binding domain, SARS-CoV-1 receptor binding domain, and MERS-CoV receptor binding domain lyophilized powders were reconstituted with water to 0.25 mg/mL in a buffer, and all solutions were kept frozen or on ice once thawed prior to use. Solutions of 0.1% BSA were prepared in 1×PBS. Spike/BSA mixtures were prepared by combining 0.1% BSA in 1×PBS with stock spike protein in equal parts. For all SERS experiments, 10 μL of protein solution was dropped onto the surface. For experiments on unmodified gold substrates, protein solution was added to the surfaces, and spectra were collected immediately. A power of 2 mW was used to acquire 20 μm×20 μm spectral maps with a 1 μm step size in the xy-plane. Considering the significant heating of the local environment during SERS measurements, photothermal damage to the surface and the sample can be avoided by utilizing near-infrared wavelengths and low powers along with imaging the surface while wet (Takase M et al. Phys. Chem. Chen. Phys. 2013, 15, 4270; Zeng Z C et al. J. Phys. Chem. (2017, 121, 11623-11631). Laser powers were optimized to avoid potential photodamage to the surfaces (Zeng Z C et al. J. Phys. Chem. C 2017, 121, 11623-11631). All SERS measurements were taken on wet substrates. For peptide-functionalized substrates, protein solution was added and allowed to bind for 30 min before rinsing with water to remove any unbound protein, and SERS measurements were obtained at a power of 570 μW with a 10 μm×10 μm map size.

SERS Data Processing and Analysis. Cosmic rays were removed from SERS maps in Windows-based Raman Environment (WiRE) software (version 5.2.10411) from Renishaw. Spectral analysis was performed in MATLAB (R2019b, The Mathworks Inc.). Multivariate curve resolution (MCR) was performed using the PLS Toolbox version 8.7.1 (Eigenvector Research Inc.).

### Results and Discussion

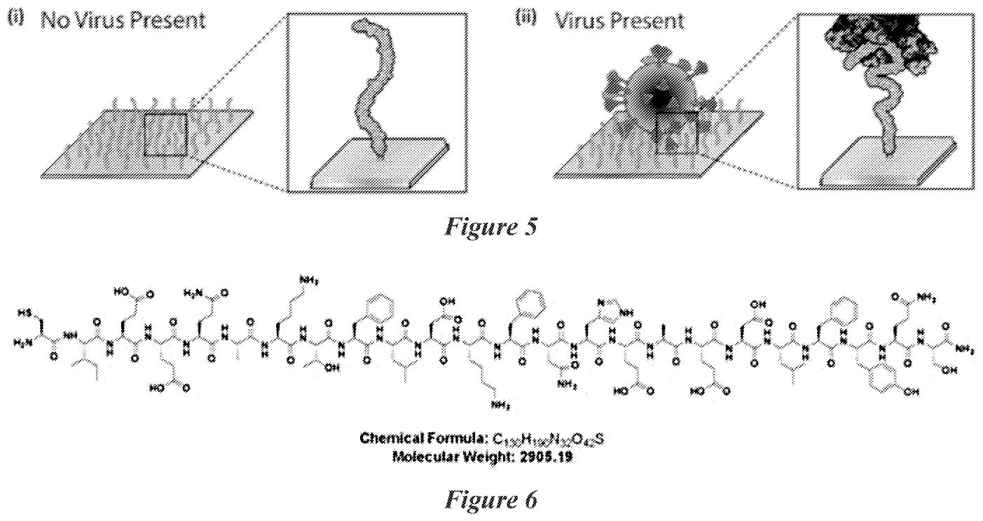

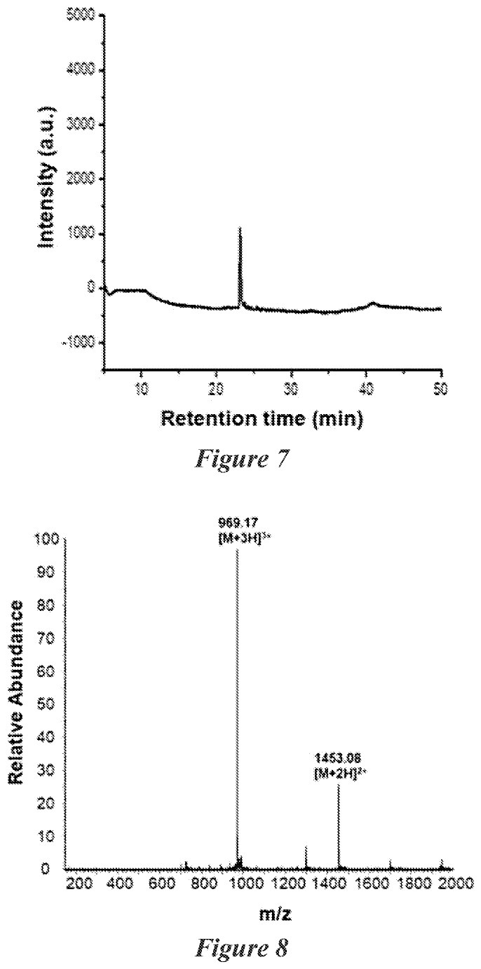

Surface Modification and Characterization. To design a SERS sensor to detect SARS-CoV-2, SERS substrates were modified with a peptide motif derived from the cell surface receptor, ACE2, which binds the receptor binding domain of the SARS-CoV-2 spike protein (Wrapp) et al. Science 2020, 367, 1260-1263; Zhang C et al. BioRxiv 2020, DOI: 10.1101/2020.03.19.999318). Displaying the spike-binding peptide (SBP) on SERS substrates will enable the selective capture of SARS-CoV-2 from complex media and its detection using SERS (FIG. 5). By synthesizing the spike-binding peptide with a cysteine residue at its N-terminus (FIG. 6-FIG. 8), a strong gold-thiol bond attaches this sequence to the gold SERS substrates.

It is ideal to achieve monolayer coverage of the capture molecule in a consistent orientation on the surface. With cysteine-terminated probes, reduction of disulfide bonds before surface modification ensures that the sulfur groups are free to bind to the substrate. Additionally, backfilling with a short-chain thiol can fill the empty spots between probe molecules, encouraging the probe to orient uniformly and in an upright position (Oberhaus F V et al. Biosensors 2020, 10, 45). This process can also displace any nonspecifically adsorbed molecules, including contaminants that might remain after cleaning.

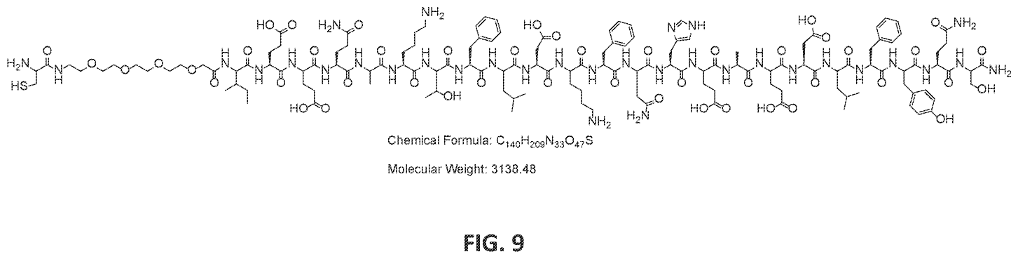

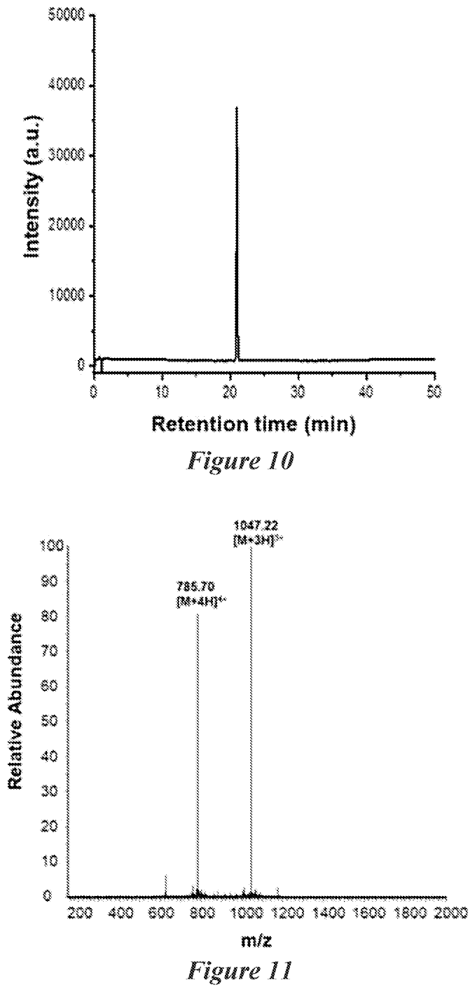

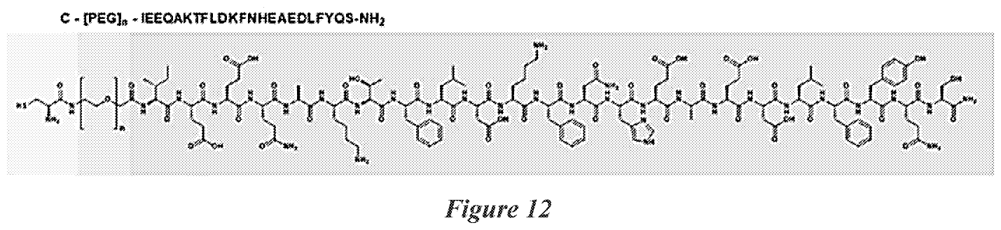

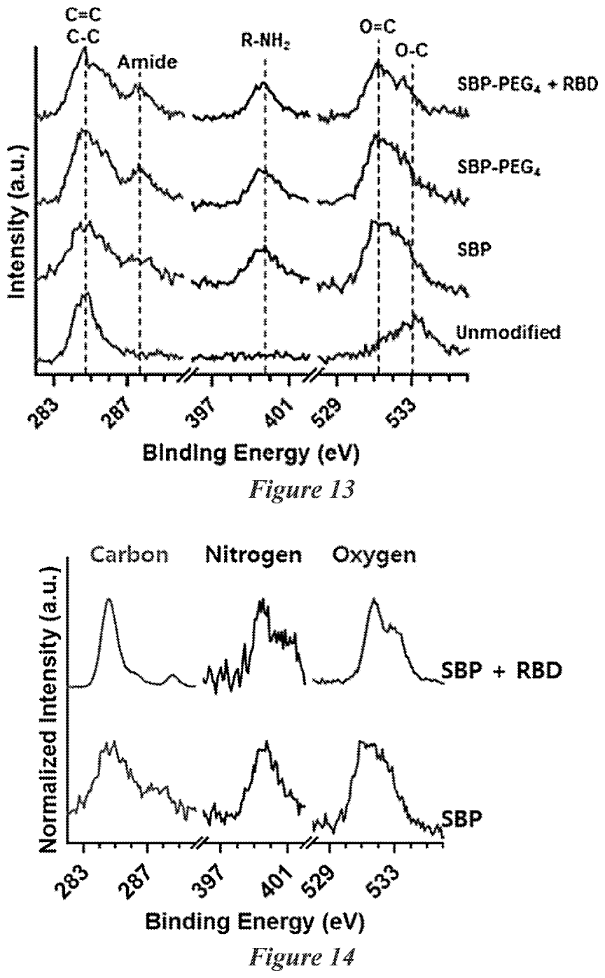

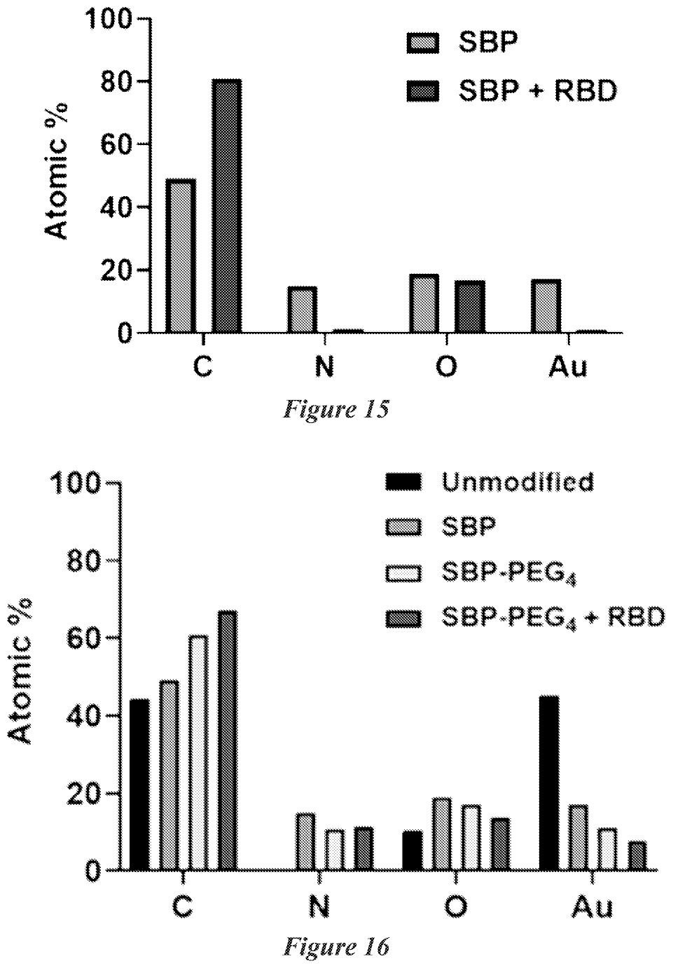

Binding of biomolecules to a surface is highly influenced by the chemical properties of the surface (Gibbs J et al. Immobilization Principles—Selecting the Surface for ELISA Assays; Corning Incorporated, Life Sciences: 2017), suggesting that the distance between the surface and the capture peptide recognition sequence could affect its binding affinity to the target molecule. Therefore, a second peptide, SBP-PEG (FIG. 9-FIG. 11), with a PEG₄ spacer between the N-terminal cysteine residue and the spike-binding motif was also examined (FIG. 12). XPS measurements show successful modification of the substrates with the peptides and RBD binding to the SBP-PEG₄ surface. From the XPS spectra (FIG. 13) of unmodified versus modified substrates, peaks appear at 288, 399, and 531 eV, indicating amide bonds, primary amines, and C═O bonds, respectively. Interestingly, the more predominant amide peak and increased nitrogen-to-gold ratio for the SBP-PEG₄-modified substrate compared to the SBP-modified substrate indicate that the linker may facilitate better attachment to the surface (N:Au ratios are 0.85 and 0.99 for SBP and SBP-PEG₄, respectively). Upon RBD binding to the SBP-PEG₄ substrate, the XPS spectra maintain a strong amide peak while the N:Au ratio increases from 0.99 to 1.45, indicating that protein is binding to the SBP-PEG₄-modified substrate. RBD binding to the SBP-modified substrate was also measured using XPS (FIG. 14-FIG. 15) with the N:Au ratio increasing from 0.85 to 1.31. Overall, quantification of the atomic composition from the XPS (FIG. 16) supports successful modification and RBD binding as indicated by the increasing N:Au ratio after both steps.

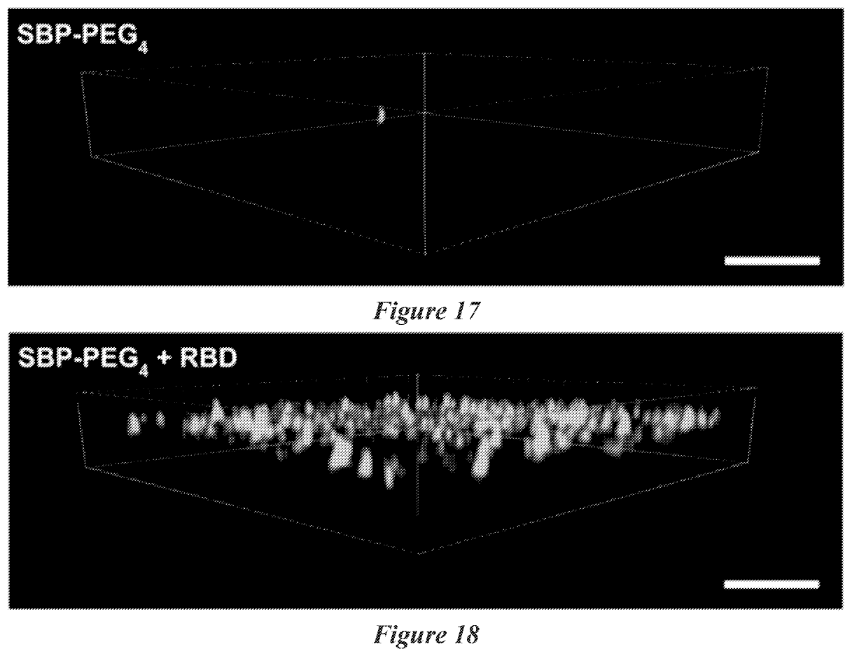

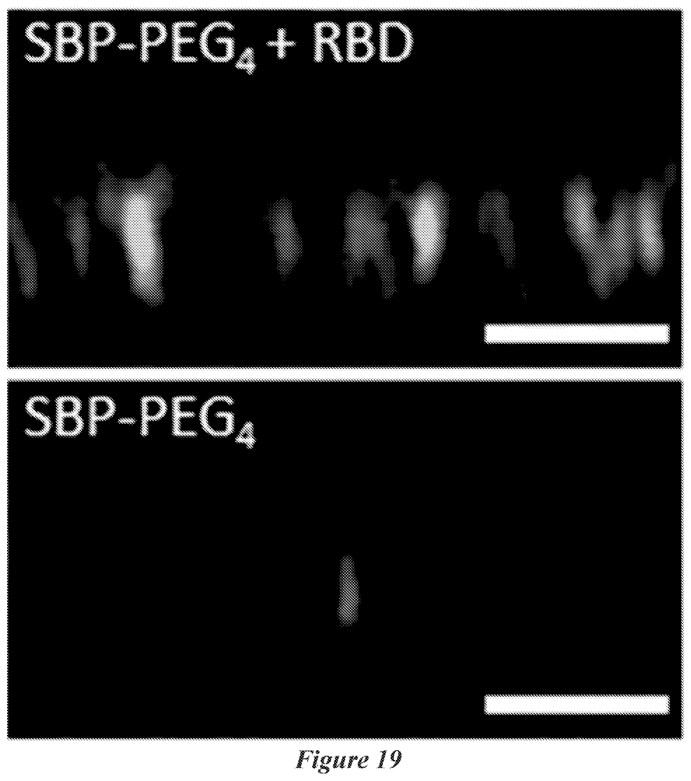

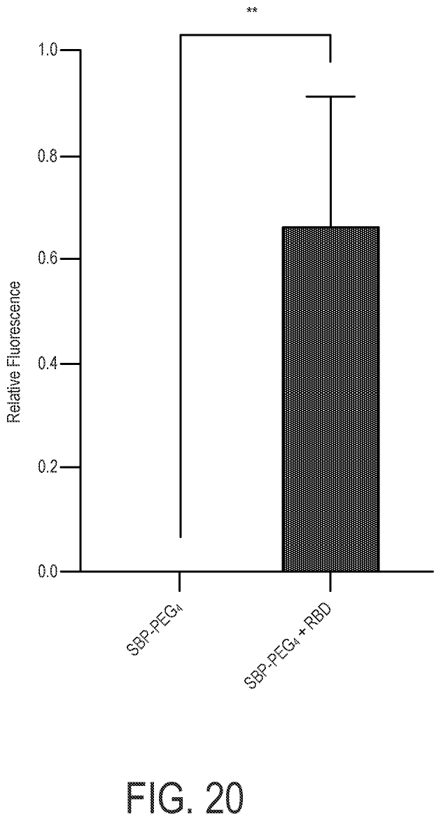

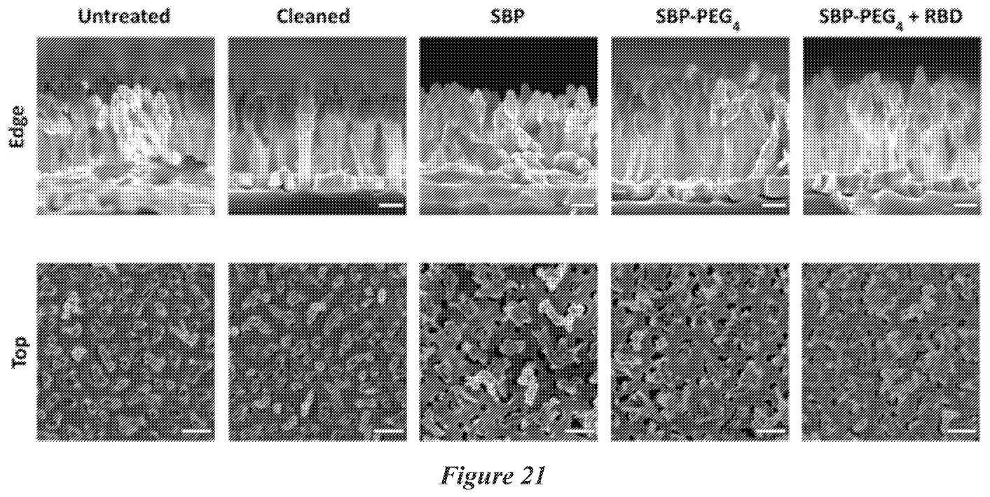

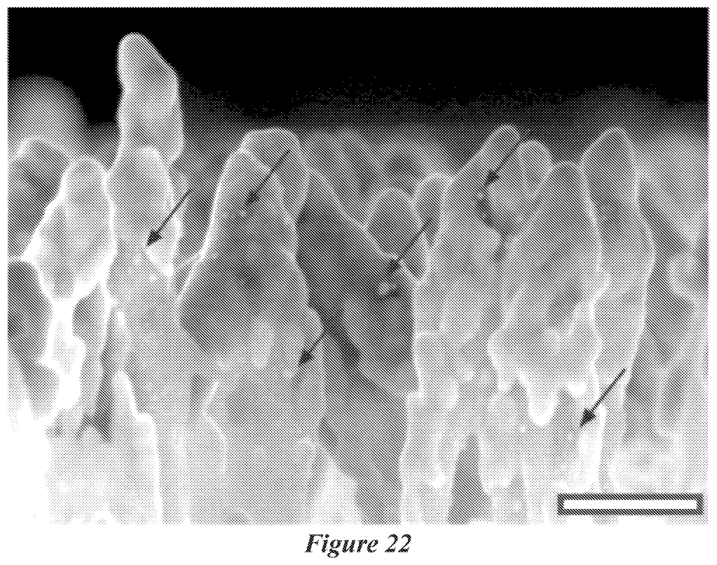

To further confirm RBD binding, SBP-PEG₄-modified substrates with and without RBD were immunolabeled with anti-RBD fluorescent antibodies and imaged using confocal laser scanning microscopy (CLSM) to create a 3D reconstruction of the surface (FIG. 17-FIG. 18). Side-view images of the substrates (FIG. 19) show minimal background signals for SBP-PEG₄ substrates, but after incubation with RBD, increased emission is observed, indicating successful R3D binding. Quantification of the relative fluorescence shows a significant increase after RB) binding (FIG. 20). SEN images of the substrates (FIG. 21) show clustering of pillars after peptide modification, consistent with the known behavior of the SERS substrate (Schmidt M S et al. Adv Mater. 2012, 24, OP11-OP18). RBD binding is visualized by immunolabeling with gold-nanoparticle-conjugated antibodies (FIG. 22).

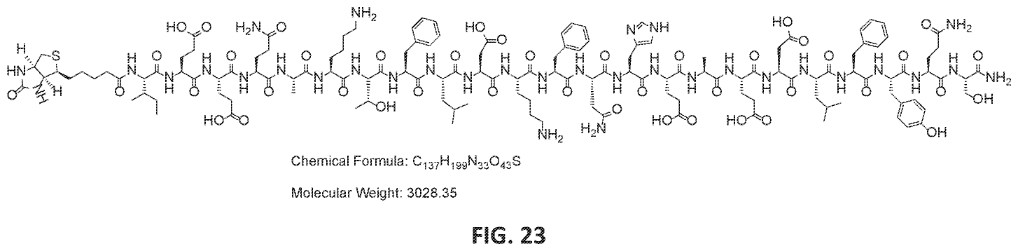

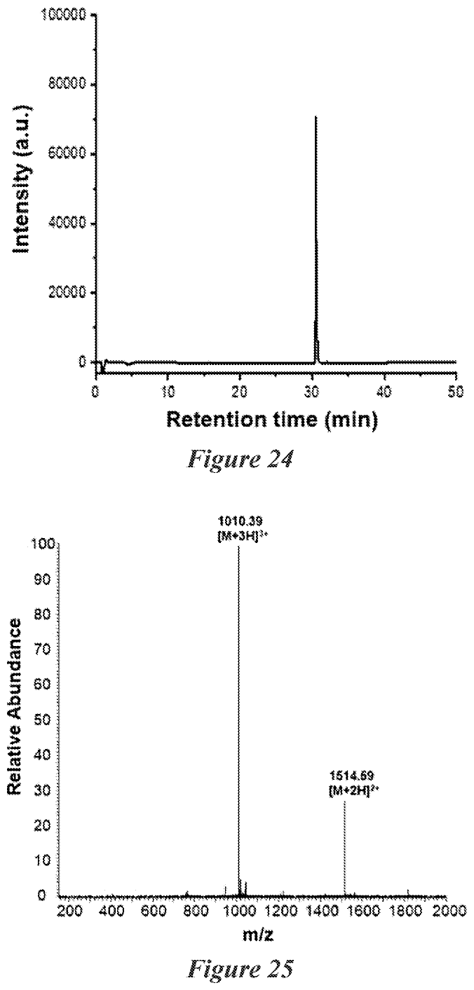

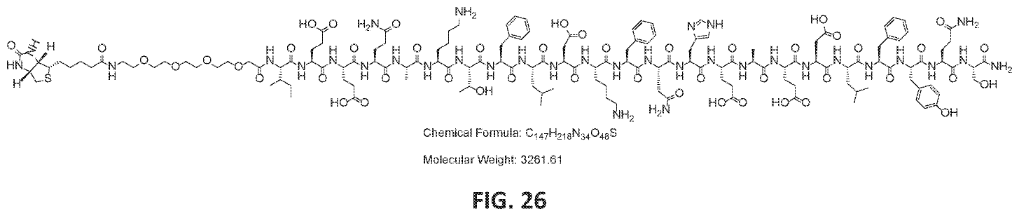

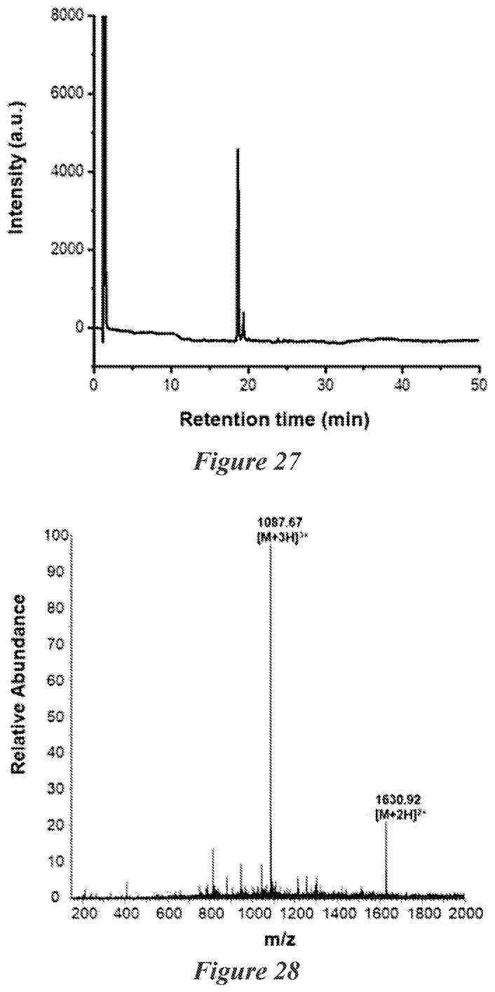

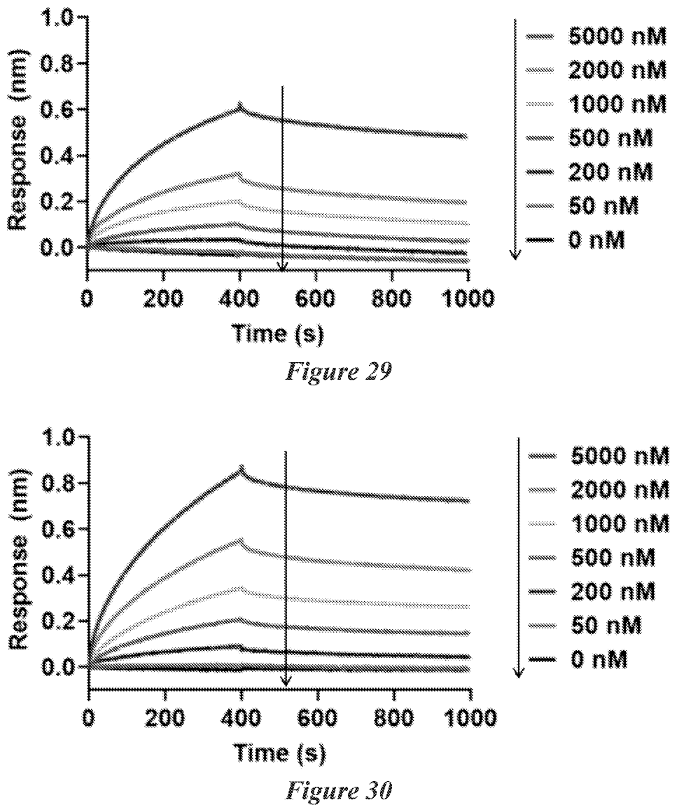

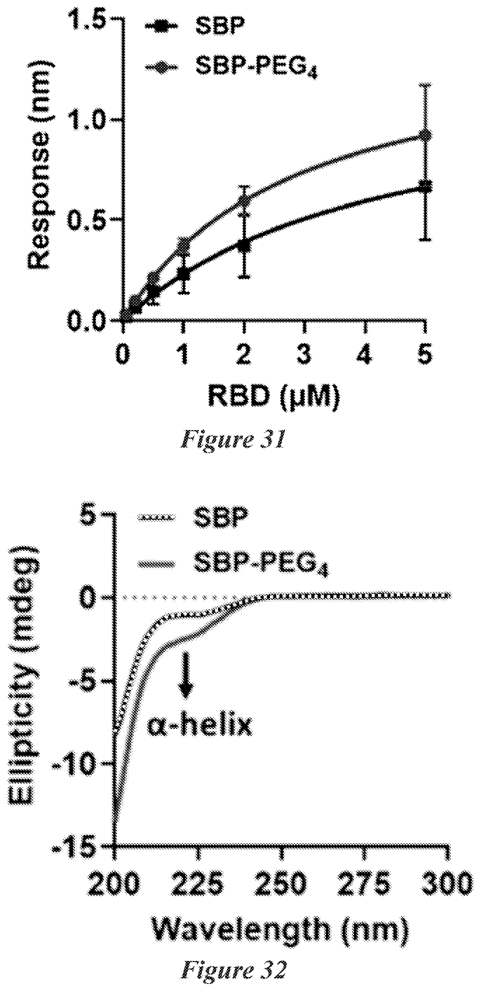

Enhancing Binding Affinity of the Capture Peptide. It was reasoned that introducing a spacer to the peptide between the surface-binding functional group and the analyte binding domain can enable better folding of the peptide—RBD complex and can therefore improve its binding affinity for the RBD. Indeed, biolayer interferometry measurements of biotinylated versions of SBP (FIG. 23-FIG. 25) and SBP-PEG₄ (FIG. 26-FIG. 28) attached to streptavidin-coated biolayer interferometry tips show a higher response to an increasing spike-RBD concentration from SBP-PEG₄ compared to the SBP sequence (FIG. 29-FIG. 30). Steady-state analysis of the biolayer interferometry response indicates that the PEG₄ spacer enhances the K_{d} of the peptide from 4.4 to 2.9 μM (FIG. 31), indicating the importance of a spacer between the surface and the spike-binding motif to allow for effective binding of the viral spike protein.

As the native spike-binding motif adopts an α-helix conformation when in the ACE2 protein, it was speculated that the spacer might affect the secondary structure of the peptide (Zhang G et al. BioRxiv 2020, DOI: 10.1101/2020.03.19.999318; Lan J et al. Nature 2020, 581, 215-220). Circular dichroism measurements show that both SBP and SBP-PEG₄ have a sharp negative peak at 200 nm, indicating significant random coil formation (FIG. 32). Interestingly, SBP-PEG₄ shows a stronger shoulder around 222 nm, which indicates that the linker could promote α-helix formation. This difference in helicity correlates with a significantly altered binding affinity, suggesting that the secondary structure can play an important role in binding the spike protein of SARS-CoV-2 and that enhancing the helicity of the peptide could provide even more improved binding affinity.

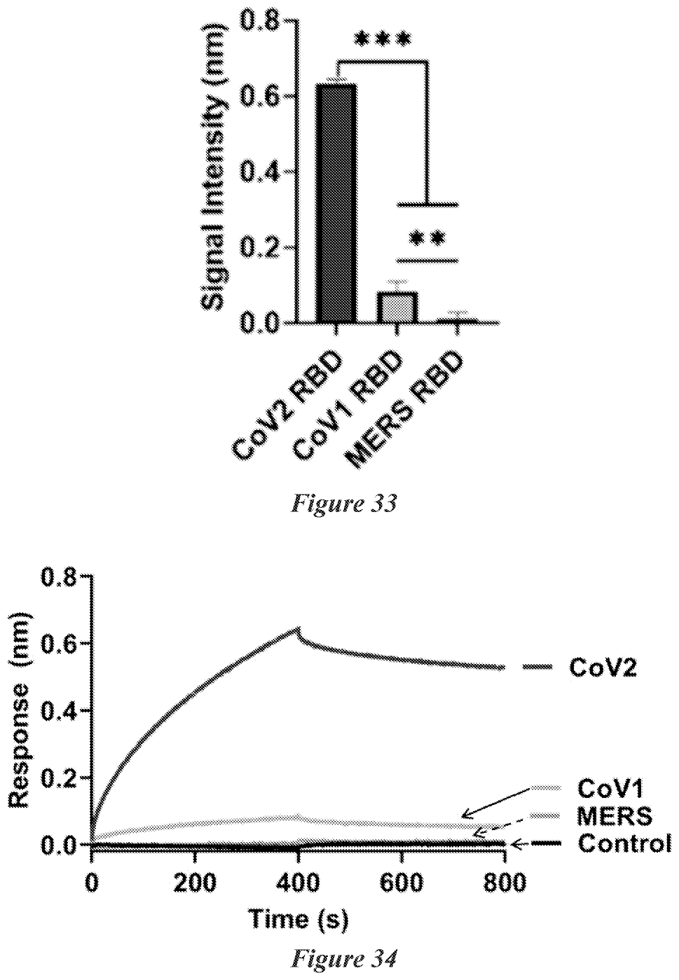

Of note, the SBP-PEG₄ peptide shows low affinity for other viruses. Biolayer interferometry was used to compare binding between the receptor binding domains of SARS-CoV-2, SARS-CoV-1, and MERS (FIG. 33 and FIG. 34). The peptide shows selectivity for SARS-CoV-2 with significantly higher response compared to SARS-CoV-1, which also binds to the ACE2 receptor. Challenging the peptide with MERS, which does not have an ACE2 binding motif, shows negligible binding. This validates the use of mimetic peptides as capture agents for sensors.

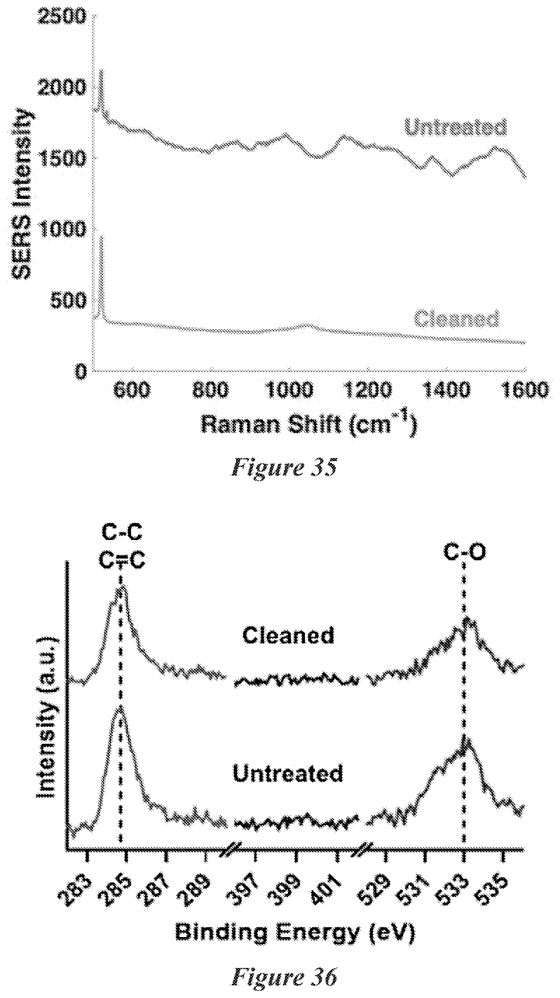

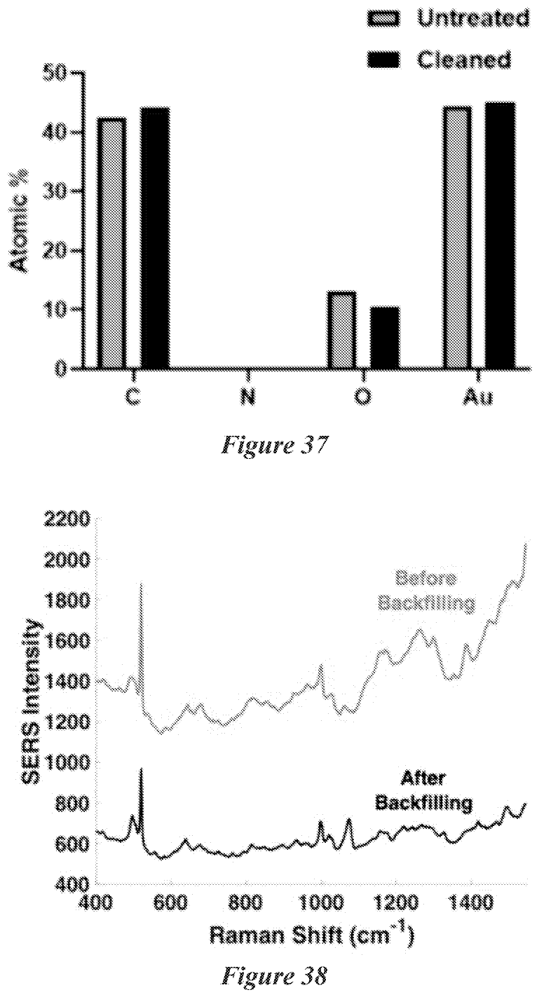

Optimizing SERS Response of Substrates to SARS-CoV-2 Spike Protein. SERS performance is dependent on successful peptide modification of the substrate, which requires a clean gold surface. Heating the substrates to 170° C. helps remove unwanted contaminants before peptide modification, resulting in a reduced SERS background (FIG. 35). XPS (FIG. 36-FIG. 37) and SEM images (FIG. 21) show that heating does not damage the substrates. Optimal surface functionalization conditions include the reduction of disulfide bonds between peptide molecules using TCEP and backfilling the surface with 2-mercaptoethanol to orient the peptide more uniformly on the surface and yield cleaner SERS spectra (FIG. 38) (Oberhaus F V et al. Biosensors 2020, 10, 45).

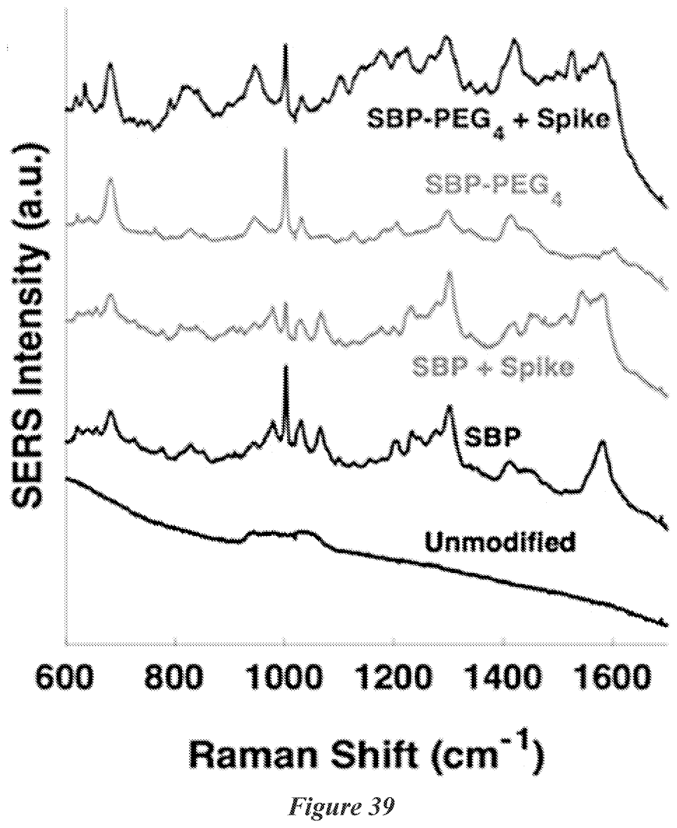

The SERS measurements of the SBP and SBP-PEG₄ peptide-modified gold SERS substrates confirm successful attachment of the peptides to the surfaces (FIG. 39). The SERS spectra of peptide-modified surfaces exhibit SERS peaks corresponding to the amino acids in the peptides (FIG. 39). SBP-PEG₄ shows bands at 635, 1002, 1032, 1275, and 1420 cm⁻¹, arising from C—S stretching, symmetric ring breathing of phenylalanine, in-plane bending of phenylalanine, phenylalanine/tyrosine CH₂ wagging, and CH₂ deformation of cysteine, respectively (Szekeres G P et al. Front. Chem. 2019, 7, 30; Freire P T C et al. Chapter 10—Raman Spectroscopy of Amino Acid Crystals, Raman Spectroscopy and Applications, Maaz, K. Ed. InTech, 2017; DOI: 10.5772/65480; Negri P et al Analyst 2014, 139, 5989-5998), FIG. 39 further shows that the SARS-CoV-2 spike protein elicits significant changes in the observed SERS spectrum. When treated with the SARS-CoV-2 spike protein, the SBP-PEG₄ surface shows more significant and additional spectral changes compared to the peptide without the spacer (FIG. 39), in agreement with its higher binding affinity for the receptor binding domain (FIG. 31-FIG. 33).

Addition of the spike protein to the SBP-PEG₄ surface shows peaks assigned to the protein: C—H stretching or N—H deformation at 793 cm⁻¹, phenylalanine out-of-plane bending at 842 cm⁻¹, α-helical skeletal vibration at 946 cm⁻¹, C—N stretching at 1103 cm⁻¹, tyrosine vibration at 1175 cm⁻¹, C—C stretching of tyrosine and phenylalanine at 1223 cm⁻¹, tryptophan rocking at 1267 cm⁻¹, amide III α-helix vibration at 1293 cm⁻¹, tryptophan C_{α}—H deformation at 1339 cm⁻¹. CH₃ symmetric stretching at 1369 cm⁻¹, NH⁺ deformation of lysine at 1526 cm indole ring of tryptophan at 1559 cm, tryptophan aromatic ring stretching at 1580 cm, and phenylalanine or tyrosine C—C ring stretching at 1601 cm⁻¹ (Szekeres G P et al. Front. Chem. 2019, 7, 30; Freire P T C et al. Chapter 10—Raman Spectroscopy of Amino Acid Crystals, Raman Spectroscopy and Applications, Maaz, K. Ed. InTech, 2017; DOI: 10.5772/65480; Rygula A et al. Raman Spectrosc. 2013, 44, 1061-1076; Lin V J C et al. Biopolymers 1976, 15, 203-218; Peticolas W L. Raman Spectroscopy of DNA and Proteins, Methods in Enzymology, Elsevier, 1995, Vol. 246, pp. 389-416, DOI: 10.1016/0076-6879(95)46019-5). These assignments are consistent with the structure of the spike protein and its receptor binding domain (Lan J et al. Nature 2020, 581, 215-220).

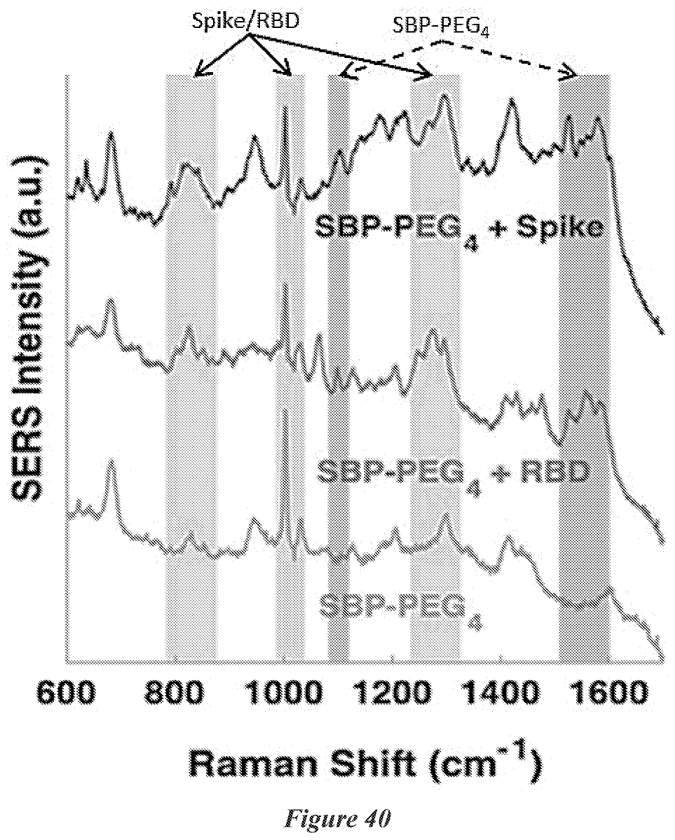

The observed SERS features in conjunction with the biolayer interferometry data indicate that SBP-PEG₄ is the preferred capture molecule. The SERS signatures of SARS-CoV-2 receptor binding domain versus the full spike protein on an SBP-PEG₄ surface show a high degree of similarity (FIG. 40), suggesting that the majority of the signal from the full spike originates from the receptor binding domain (Wang H et al. Faraday Discuss. 2015, 178, 221-235; Wang H et al. ChemPhysChem 2014, 15, 3944-3949; Xiao L et al. Annal. Chem. 2016, 88, 6547-6553). As noted in FIG. 40, addition of either the spike or the receptor binding domain triggers the appearance of similar peaks (highlighted in maroon), such as the bands around 1600 cm⁻¹ from tryptophan, along with changes in the relative intensities of bands from the peptide itself (highlighted in teal), supporting a change in orientation associated with protein binding.

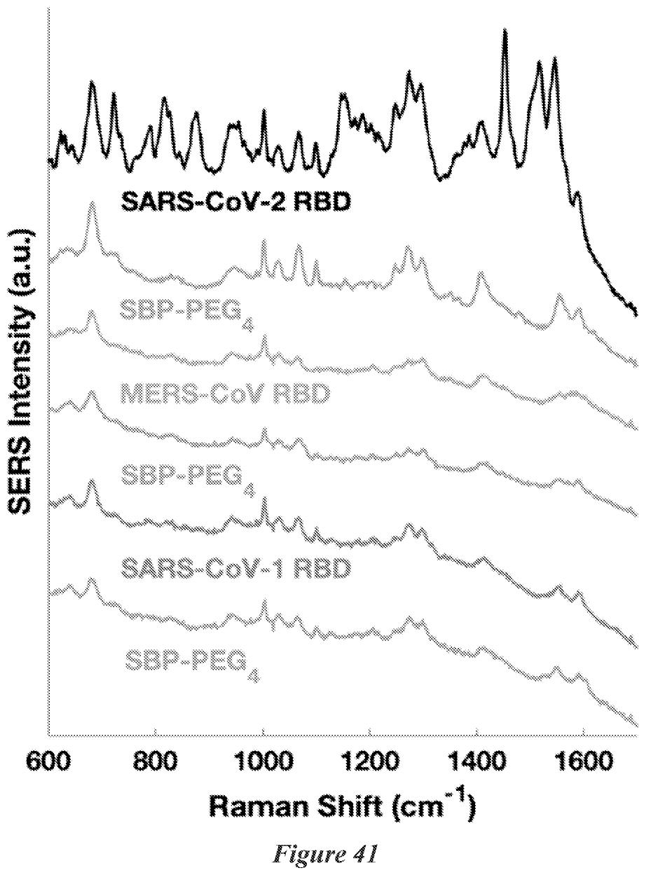

The SBP-PEG₄ surface demonstrates specificity for SARS-CoV-2 receptor binding domain, as opposed to the receptor binding domain of two other human coronaviruses, SARS-CoV-1 and MERS-CoV, in agreement with the previously discussed biolayer interferometry results. In FIG. 41, the sensor yields an intense SERS signal from 5 μM SARS-CoV-2 receptor binding domain but no response from of SARS-CoV-1 receptor binding domain and MERS-CoV receptor binding domain under the same conditions.

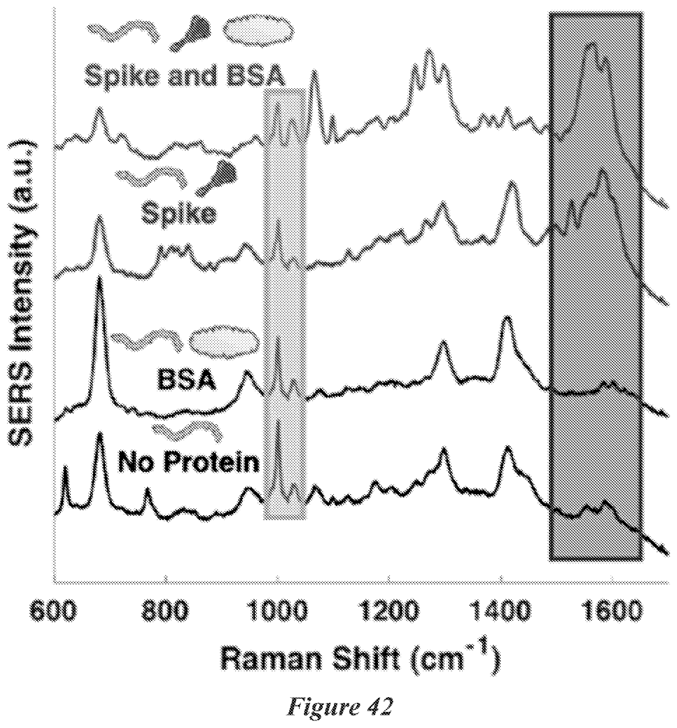

Evaluating Selectivity and Quantitative Capabilities of the SERS Sensor. FIG. 42 shows the SERS spectra obtained from SBP-PEG₄-functionalized substrates treated with either 2 μM spike protein, 15 μM bovine serum albumin (BSA), or a spike and BSA mixture. BSA was mixed with the SARS-CoV-2 spike protein in an 8:1 ratio to mimic the protein-rich environment of saliva and blood. In all of these experiments, the SERS signal was acquired from each SBP-PEG₄-modified surface before and after treatment with protein. In FIG. 42, the SERS spectrum in the presence of spike protein shows distinct differences from the peptide-modified surface, notably the feature around 1600 cm⁻¹ (as indicated by the maroon box in FIG. 42), which is likely associated with tryptophan residues present in the receptor binding domain of the spike protein but not present in SBP-PEG₄. These differences are unique to the surfaces containing spike proteins and are not observed in the presence of BSA alone. This competition assay assessed the selectivity of the SBP-PEG₄-modified surface, demonstrating the advantage of the capture peptide.

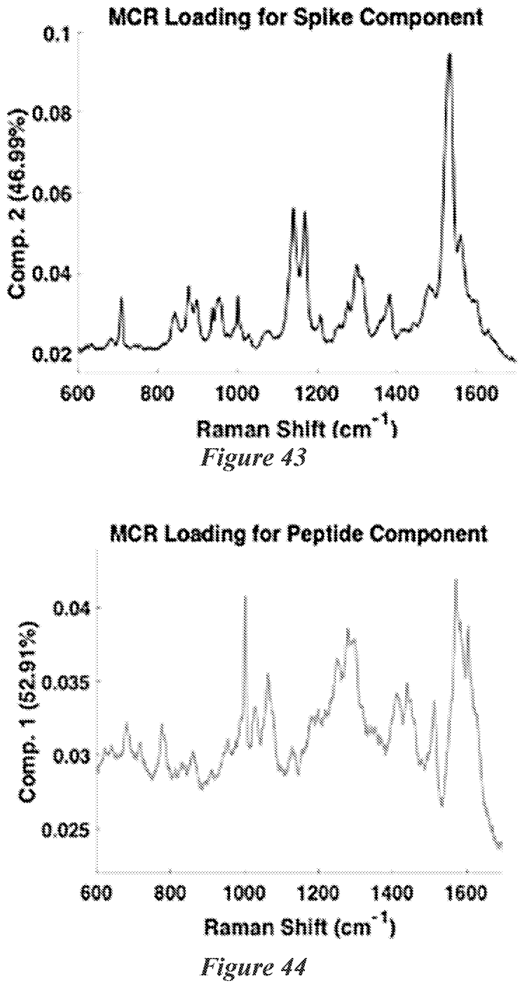

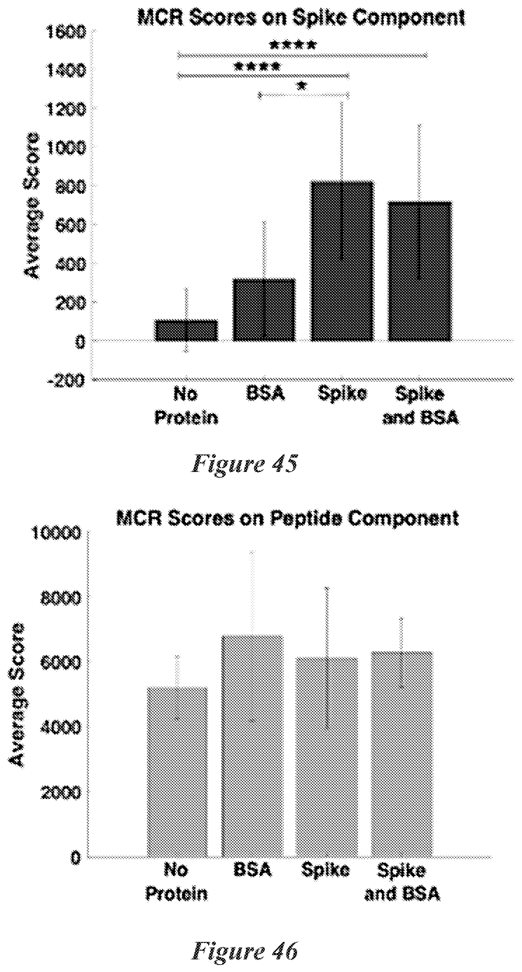

Multivariate curve resolution (MCR) was used to generate a model capturing the spectral changes observed from the spike protein binding to the SBP-PEG₄-modified SERS substrate. The stochastic nature of molecules interacting with hotspots on the surface is known to produce some variance in the SERS spectra. Multivariate curve resolution generates components representative of the average spectra observed in all the data. The calibration data consisted of SERS maps from an SBP-PEG₄-modified SERS substrate challenged with a high concentration of the spike protein, generating a two-component model. The loadings derived from the multivariate curve resolution model are consistent with the spectral changes observed from the spike protein (FIG. 43) and the SBP-PEG₄-modified SERS substrate (FIG. 44). The strong spectral feature between 1500 and 1600 cm⁻¹ in the loading for the second component (FIG. 43) correlates to a similar feature present in the average spectra of the spike-containing samples (FIG. 42). The emergence of signal in this region appears to be the key indicator of spike binding. Data collected on four different days across four different substrates, which produced a total of five spike maps, five BSA maps, eight mixture maps, and 18 maps with no protein, were analyzed with the resulting model. During the process, Grubbs' test removed one out of the 18 total peptide maps as an outlier from the validation set. FIG. 45 shows that the addition of both the spike and the spike/BSA mixture causes a statistically significant increase (p<0.0001) in the sample's score on the spike protein component compared to the surface with no protein. Meanwhile, FIG. 46 shows that the scores on the peptide component do not change upon the addition of the protein solutions. The data in FIG. 45 also exhibits a significant difference (p=0.05) between the BSA-treated and the spike-treated samples on the spike component. The score of BSA on the spike component likely represents the small amount of overlap between an off-target protein SERS signal and the SERS spectra of the spike protein, validating that the peptide provides the sensor with selectivity for the SARS-CoV-2 spike protein. Upon addition of the mixture and subsequent rinsing of the surface, the BSA is likely washed away, while the spike protein remains bound to the peptide on the surface. Additionally, the BSA may promote binding of the spike protein to the peptide, as indicated by the similar spike component scores of the 2 μM spike and the mixture containing only 1 μM spike. BSA is typically used as a blocking agent to prevent nonspecific adsorption (Lichtenberg J Y et al. Sensors 2019, 19, 2488); however, since the surface is modified with both a peptide and a backfilling agent, this surface effect is unlikely to affect binding. Instead, the BSA may be acting as a molecular chaperone for the spike protein, preventing aggregation and encouraging proper folding (Finn T E et al. J. Biol Chem. 2012, 287, 21530-21540), thus ensuring conditions conducive to peptide-spike binding.

It is important to note that this sensor is designed to mimic the ACE2 receptor found in humans and that the model selects for the spike protein of SARS-CoV-2. Because variants of the virus are expected to also infect cells through the ACE2 receptor, this sensor is expected to also bind to the variants. For the sensing of variants, the model may need to be retrained, particularly in the case where the receptor binding domain in the variant is altered (Yuan M et al. Science 2021, 373(6556), 818; Zhang J et al bioRxiv, 2020, 525-530, DOT. 10.1101/2020.10.13.337980: Singh J et al. Viruses 2021, 13, 439).

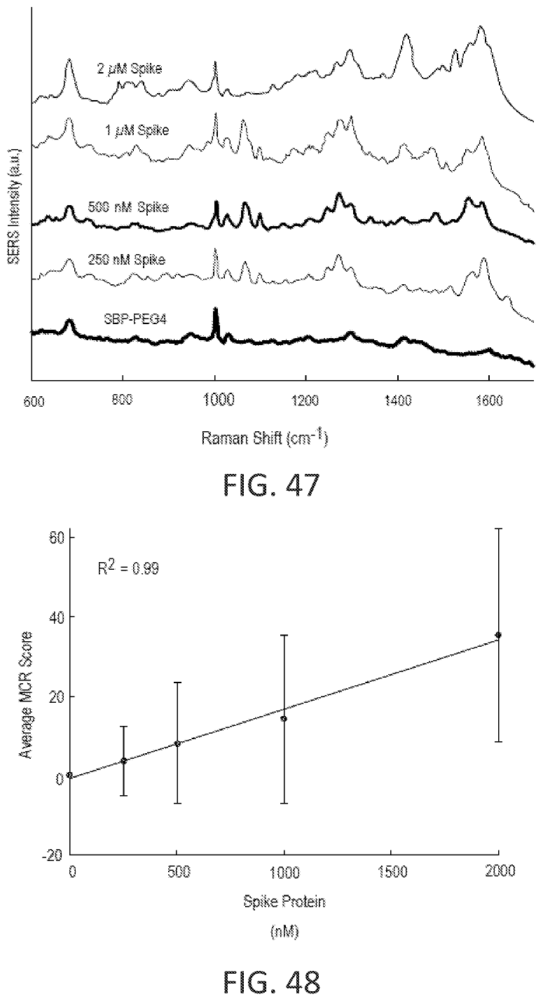

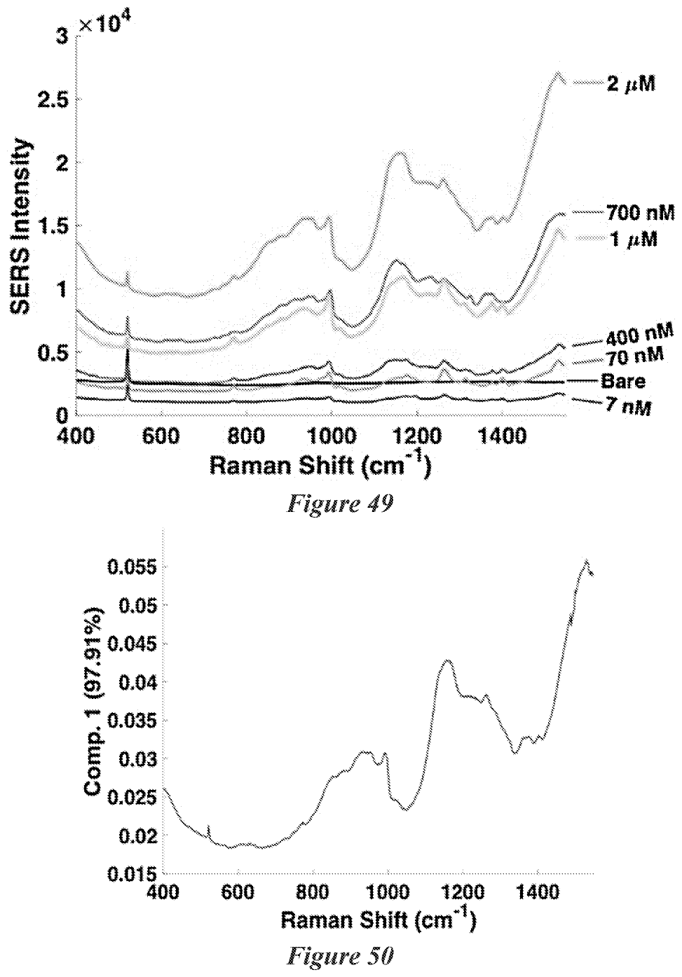

Finally, the SBP-PEG₄-modified surfaces demonstrate a linear SERS response as a function of SARS-CoV-2 spike protein concentration. SERS maps were acquired from SBP-PEG₄ substrates treated with five different concentrations of spike protein. It was observed that the heterogeneity of the SERS substrate required analysis of an average response from a 10 μm×10 μm area for reliable detection. This could also be achieved with a larger illumination area in a practical device. The spectra from five naps from each surface were averaged and normalized to the height of the phenylalanine peak at 1002 cm⁻¹ as an internal standard (FIG. 47). The average scores for the normalized spectra on the previously discussed multivariate curve resolution model (FIG. 43, FIG. 45) generated a calibration curve (FIG. 48) for the SARS-CoV-2 spike protein on the SBP-PEG₄-modified surface, giving a limit of detection (LOD) of 300 nM. Here, limit of detection is calculated as where Su is the standard deviation in y and m is the slope of the calibration curve. The SBP-PEG₄ sensor has an limit of detection about two times lower than that of an unmodified surface (FIG. 49-FIG. 52) and demonstrates better selectivity, as shown by the competition assay (FIG. 42).

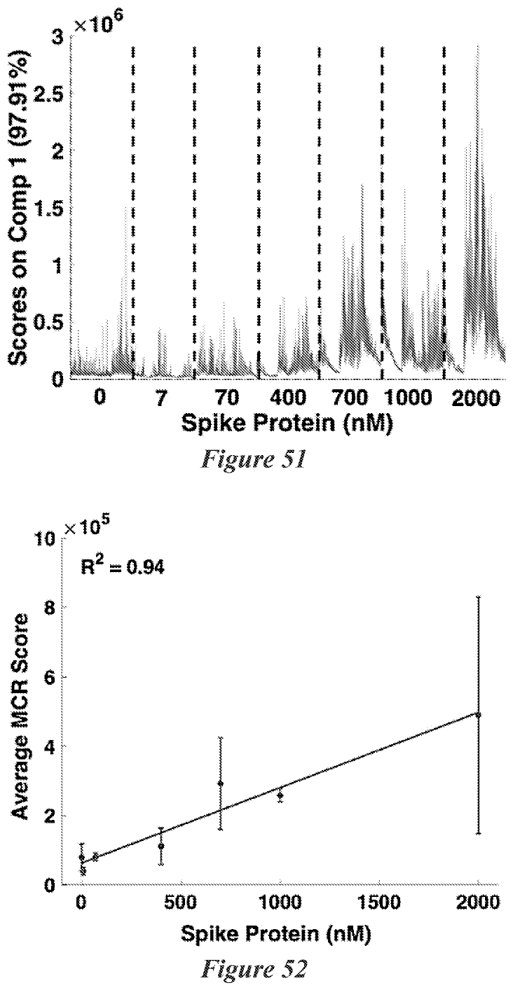

SARS-CoV-2 spike protein on bare substrates yielded a concentration dependent SERS response (FIG. 49). Bands observed at 771, 995, 1155, 1261, 1361, 1376, 1403, and 1530 cm⁻¹ correspond to vibrational modes of tryptophan, phenylalanine, and tyrosine, the aromatic amino acids in the protein (Nguyen A-H et al. Rev. Anal. Chem. 2017, 36, 20160037; Nguyen H L et al. J. Phys. Chem. B 2020, 124, 7336-7347). A one component multivariate curve resolution model created from this dataset provided a component spectrum displaying the unique SERS signature of the spike protein (FIG. 50). Plotting the scores for each spectrum based on this multivariate curve resolution component (FIG. 51) resulted in a calibration curve (FIG. 52) showing a linear dependence on analyte concentration and indicating a limit of detection of 500 nM.

CONCLUSIONS. The use of a SERS substrate modified with a virus-capture peptide provides selective detection of SARS-CoV-2 proteins in complex media. From starting with a clean surface to implementing an effective target-binding sequence, designing a functional peptide-based SERS sensor requires careful attention to detail and consideration of several factors. Notably, using a linker to offset the protein-binding sequence of the peptide from the surface impacts binding, potentially by altering the conformation of the peptide. The SBP-PEG₄ SERS sensor shows improved detection of the SARS-CoV-2 spike protein at lower concentrations compared to the unmodified surface. Consistent with previous findings, the SERS signal of this protein appears to be derived from the receptor binding domain. Variants of the SARS-CoV-2 virus are reported to have mutations in the receptor binding domain (Yuan M et al. Science 2021, 373(6556), 818; Zhang J et al. bioRx iv, 2020, 525-530, DOI: 10.1101/2020.10.13.337980; Singh 0.1 et al. Viruses 2021, 13, 439), but since SBP-PEG₄ mimics the natural binding site of the virus, this SERS sensor will likely still bind these variants, and the model could be retrained to detect them without engineering a new sensor. Overall, the improved limit of detection and the selectivity of the sensor provide the basis for the utilization of a peptide-based SERS assay for detecting SARS-CoV-2 as well as other emerging viruses in the future.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. An assay for detection of a target virus via Surface Enhanced Raman Spectroscopy (SERS), the assay comprising:
a peptide-modified nanostructured metal comprising a nanostructured metal having a first plurality of peptides attached to a surface thereof,
wherein each of the first plurality of peptides comprises a capture portion configured to capture and selectively bind with at least a first portion of the target virus,
wherein the capture portion of each of the first plurality of peptides has an average length of from 3 to 60 amino acids, and
wherein the surface of the nanostructured metal is configured to enhance a Raman signal of at least a second portion of the target virus bound to the capture portion of one or more of the first plurality of peptides.

2. (canceled)

3. The assay of claim 1, wherein the nanostructured metal comprises a metal selected from the group consisting of Pt, Au, Ag, Cu, Al, and combination thereof.

4. (canceled)

5. The assay of claim 1, wherein the nanostructured metal comprises a metal modified with a nanostructure.

6. The assay of claim 1, wherein the nanostructured metal comprises a plurality of metal particles, such that the peptide-modified nanostructured metal comprises a plurality of peptide-modified metal particles.

7. (canceled)

8. (canceled)

9. The assay of claim 6, wherein the plurality of peptide-modified metal particles are at least partially dispersed in a solvent or wherein the plurality of peptide-modified metal particles are disposed on a substrate.

10. (canceled)

11. (canceled)

12. The assay of claim 1, wherein the surface of the nanostructured metal further comprises a plurality of ligands attached thereto.

13-18. (canceled)

19. The assay of claim 1, wherein the target virus comprises a DNA virus, an RNA virus, or a combination thereof.

20. The assay of claim 1, wherein the target virus comprises an influenza virus, a coronavirus, or a combination thereof.

21. The assay of claim 1, wherein each of the first plurality of peptides further includes a first spacer portion, the first spacer portion being adjacent the capture portion and configured to space the capture portion away from the surface of the nanostructured metal.

22. The assay of claim 21, wherein the first spacer portion comprises a substituted or unsubstituted aliphatic chain, an amino acid, a third peptide, or a combination thereof.

23. The assay of claim 21, wherein the first spacer portion comprises poly(ethylene glycol).

24. The assay of claim 21, wherein the first spacer portion has an average length of from 1 nm to 10 nm.

25-29. (canceled)

30. The assay of claim 1, wherein the first portion of the target virus comprises a viral protein.

31. The assay of claim 1, wherein the first portion of the target virus is a surface protein.

32-37. (canceled)

38. The assay of claim 1, wherein the capture portion of each of the first plurality of peptides is a biomimetic peptide.

39. The assay of claim 1, wherein the first plurality of peptides are covalently or ionically bound to the surface of the nanostructured metal.

40-43. (canceled)

44. The assay of claim 1, wherein the first plurality of peptides are attached to the surface of the nanostructured metal substantially homogeneously across the surface of said nanostructured metal.

45. A method of making the assay of claim 1, the method comprising making the peptide-modified nanostructured metal.

46-48. (canceled)

49. A method comprising:
contacting the assay of claim 1 with a liquid sample;
subsequently collecting a surface enhanced Raman signal from the liquid sample and the assay; and
processing the surface enhanced Raman signal to determine a property of the liquid sample.

50-65. (canceled)

66. A device comprising:
a receptacle configured to at least partially contain the assay of claim 1;
an excitation source;
a detector; and
a computing device;
wherein the receptacle is further configured to position the assay such that the assay is in optical communication with the excitation source and the detector; and
wherein the computing device is configured to receive and process an electromagnetic signal from the detector;
wherein, when the device is assembled together with a liquid sample, then:
the receptacle is configured to at least partially contain the assay in contact with the liquid sample and position the assay in contact with the liquid sample such that the assay and the liquid sample are in optical communication with the excitation source and the detector;
the excitation source is configured to apply an excitation signal to the liquid sample and the assay;
the detector is configured to collect a surface enhanced Raman signal from the liquid sample and the assay; and
the computing device is configured to process the surface enhanced Raman signal to determine a property of the liquid sample.

67-81. (canceled)
